(19) United States
(12) Patent Application Publication
(10) Pub. No.: US 2025/0047442 A1
(43) Pub. Date: Feb. 6, 2025

(54) DEMODULATION REFERENCE SIGNAL MUTING

(71) Applicant: Fraunhofer-Gesellschaft zur Förderung der angewandten Forschung e.V., München (DE)

(72) Inventors: Arman AHMADZADEH, Erlangen (DE); Geordie GEORGE, Erlangen (DE); Thomas HEYN, Erlangen (DE); Sutharshun VARATHARAAJAN, Erlangen (DE)

(73) Assignee: Fraunhofer-Gesellschaft zur Förderung der angewandten Forschung e.V., München (DE)

(21) Appl. No.: 18/800,098

(22) Filed: Aug. 11, 2024

Related U.S. Application Data
(63) Continuation of application No. PCT/EP2023/053397, filed on Feb. 10, 2023.

(30) Foreign Application Priority Data
Feb. 11, 2022 (EP) 22156367.9
Feb. 8, 2023 (WO) PCT/EP2023/053120

(51) Int. Cl. H04L 5/00; H04W 72/231; H04W 76/20

(52) U.S. Cl. CPC H04L 5/0051; H04W 72/231; H04W 76/20

(57) ABSTRACT

A user device, UE, for a wireless communication system, like a 3rd Generation Partnership Project, 3GPP, system, is disclosed. The UE receives and/or transmits one or more physical channel transmissions. The one or more of the physical channel transmissions are received or transmitted without any associated DeModulation Reference Signal, DMRS, or with a partial or full DMRS muting.

### CROSS-REFERENCE TO RELATED APPLICATIONS

This application is a continuation of copending International Application No. PCT/EP2023/053397, filed Feb. 10, 2023, which is incorporated herein by reference in its entirety, and additionally claims priority from European Application No. 22156367.9, filed Feb. 11, 2022, and from International Application No. PCT/EP2023/053120, filed Feb. 8, 2023, which are also incorporated herein by reference in their entirety.

### TECHNICAL FIELD

The present invention relates to the field of wireless communication systems or networks, more specifically to the use of reference signals, like the DeModulation Reference Signal. DMRS, used in the coherent demodulation of various physical layer channels. Embodiments of the present invention are directed to a DMRS overhead reduction.

### BACKGROUND OF THE INVENTION

FIG. 1A and FIG. 1B are schematic representations of an example of a terrestrial wireless network 100 including, as is shown in FIG. 1A, the core network 102 and one or more radio access networks RAN1, RAN2, . . . . RANN. FIG. 1B is a schematic representation of an example of a radio access network RANn that may include one or more base stations gNB1 to gNB5, each serving a specific area surrounding the base station schematically represented by respective cells 1061 to 1065. The base stations are provided to serve users within a cell. The one or more base stations may serve users in licensed and/or unlicensed bands. The term base station, BS, refers to a gNB in fifth generation, 5G, networks, an eNB in UMTS/LTE/LTE-A/LTE-A Pro, or just a base station (BS) in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANn may include more or less such cells, and RANn may also include only one base station. FIG. 1B shows two users UE1 and UE2, also referred to as user device or user equipment, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. This may be realized on licensed bands or on unlicensed bands. Further, FIG. 1B shows two further devices 1101 and 1102 in cell 1064, like IoT devices, which may be stationary or mobile devices. The device 1101 accesses the wireless communication system via the base station gNB4 to receive and transmit data as schematically represented by arrow 1121. The device 1102 accesses the wireless communication system via the user UEs as is schematically represented by arrow 1122. The respective base station gNB1 to gNB5 may be connected to the core network 102, e.g., via the S1 interface, via respective backhaul links 1141 to 1145, which are schematically represented in FIG. 1B by the arrows pointing to “core”. The core network 102 may be connected to one or more external networks. The external network may be the Internet, or a private network, such as an Intranet or any other type of campus networks, e.g., a private

WiFi communication system or a 4G or 5G mobile communication system. Further, some or all of the respective base station gNB1 to gNB5 may be connected, e.g., via the S1 or X2 interface or the XN interface in 5G New Radio, NR, with each other via respective backhaul links 1161 to 1165, which are schematically represented in FIG. 1B by the arrows pointing to “gNBs”. A sidelink channel allows direct communication between UEs, also referred to as device-to-device, D2D, communication. The sidelink interface in 3GPP is named PC5.

The radio access technology, RAT, in a fifth generation, 5G, mobile communications system, also known as 5G new radio, NR, provides a higher level of performance and flexibility than the previous generations of mobile communications systems. 5G mobile communications have been driven by the need to provide ubiquitous connectivity for applications as diverse as automotive communication, remote control with feedback, video downloads, as well as data applications for Internet-of-Things, IoT, devices, machine type communication, MTC, devices, etc. 5G wireless technology brings several main benefits, such as faster speed, shorter delays and increased connectivity. The third-generation partnership project, 3GPP, provides the complete system specification for the 5G network architecture, which includes at least the radio access network, RAN, the core transport networks, CN, and service capabilities.

The wireless communication network system may be any single-tone or multicarrier system using frequency-division multiplexing, like an orthogonal frequency-division multiplexing, OFDM, system, an orthogonal frequency-division multiple access, OFDMA, system, or any other Discrete Fourier Transform, DFT, based signal with or without cyclic prefix, CP, e.g. a DFT-spread OFDM, DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may also be used. The wireless communication system may operate, e.g., in accordance with the LTE-Advanced Pro standard, the 5G or NR standard or any other standard using any of the aforementioned waveforms.

For a data transmission, a physical resource grid may be used. The physical resource grid may comprise resource blocks, RBs, and symbols, that in turn comprise a set of resource elements, REs, to which various physical channels and physical signals are mapped. For example, the physical channels may include the physical downlink, DL, uplink, UL, and/or sidelink, SL, shared channels, respectively, abbreviated as PDSCH, PUSCH, PSSCH, carrying user specific data, also referred to as downlink, uplink or sidelink payload data, the physical broadcast channel, PBCH, carrying for example a master information block, MIB, and a system information block, SIB, the physical downlink, uplink and/or sidelink control channels, respectively abbreviated as PDCCH, PUCCH, PSCCH, carrying for example the downlink control information, DCI, the uplink control information, UCI, or the sidelink control information, SCI. For the uplink, the physical channels may further include the physical random-access channel, PRACH or RACH, used by UEs for accessing the network once a UE is synchronized and obtains the MIB and SIB. The physical signals may comprise reference signals, RSs, synchronization signals, SSs, and the like. The resource grid may comprise a frame or radio frame having a certain duration, like 10 milliseconds, in the time domain and having a given bandwidth in the frequency domain. The radio frame may have a certain number of subframes of a predefined length, e.g., 2 subframes with a length of 1 millisecond. Each subframe may include two slots of a number of OFDM symbols depending on the cyclic prefix (CP) length. In 5G, each slot comprises 14 OFDM symbols or 12 OFDM symbols based on normal CP and extended CP, respectively. A frame may also comprise of a smaller number of OFDM symbols, e.g. when utilizing shortened transmission time intervals, TTIs, or a mini-slot/non-slot-based frame structure comprising just a few OFDM symbols. Slot aggregation is supported in 5G NR and hence a data transmission may be scheduled to span one or multiple slots. Slot format indication informs a UE whether an OFDM symbol is downlink, uplink or flexible.

The following terms are used in this description:
The term higher layer in the following, when used in isolation, denotes any communication layer above the physical layer in the protocol stack. When the term is used in connection with a specific layer, it denotes any communication in the protocol stack above the layer.
The term preconfigured or fixed/predetermined/provided in the specifications may mean the following: one or more rules and/or methods and/or particulars regarding one or more certain parameters are provided in the standard specifications that the UE and/or any network entity is supposed to follow or implement.
The term configured may mean the following: one or more rules and/or methods and/or particulars regarding one or more certain parameters as provided in the standard specifications that the UE is supposed to follow or implement are provided to the UE by one or more network entities, e.g., via higher layer signaling, like radio resource control, RRC signaling.
The term serving cell and carrier component, CC, may be used interchangeably in this description as a serving cell configured for a UE, which, usually, is a separate physical carrier centered around a particular carrier frequency. Depending on the frequency of a component carrier/serving cell, the size of the cell and the beamformed reference signals may vary.
The terms layer, stream and DMRS port may be used interchangeably.
The term PDxCH or PDXCH may indicate either the physical downlink shared channel, PDSCH, or the physical downlink control channel, PDCCH, while PUxCH or PUXCH may indicate either the physical uplink shared channel, PUSCH or the physical uplink control channel, PUCCH.
The term PxxCH or PXXCH may denote a PDSCH, PDCCH, PUSCH or PUSCH.
The terms PDCCH and DCI may be used interchangeably.
The terms PUCCH and UCI may be used interchangeably.
The terms PSCCH and SCI may be used interchangeably.

Now, the use of DeModulation Reference Signals, DMRS, in accordance with the current or conventional third generation partnership project, 3GPP, fifth generation, 5G, New Radio, NR, specifications is described. The DMRS is a reference signal used for the coherent demodulation of a physical downlink shared channel, PDSCH, transmission, a physical downlink control channel, PDCCH, transmission, a physical uplink shared channel, PUSCH transmission or a physical uplink control channel, PUCCH, transmission. It is transmitted together with each of the channels mentioned above and the design of the DMRS for each one of them is different in the 5G NR specifications. In the following, the DMRS is described with reference to the PDSCH in 5G NR.

The DMRS is transmitted together with the PDSCH. A PDSCH transmission in a given slot spans N_{sym}^{PDSCH} OFDM symbols, also referred to as symbols hereafter, and N_{sc}^{PDSCH} subcarriers. The REs in the time-frequency grid in which the DMRS is transmitted are embedded in the allocation provided for the PDSCH. For a given PDSCH allocation in a 5G NR slot in the physical layer frame structure, the DMRS allocation for the PDSCH is determined by multiple DMRS parameters. Typically, PDSCH DMRS is available at one or more positions in the slot comprising the PDSCH, and each position comprises DMRS REs in one or two consecutive symbols. The DMRS configuration of a physical channel is provided to the UE by a network node via a higher layer (e.g., Radio Resource Control). The following parameters determine the allocation of the DMRS of a PDSCH and the network provides them to the UE, e.g., via a higher layer configuration (either provided in the DMRS configuration or separately):
Mapping type: The first symbol with DMRS in the first position is determined by the PDSCH mapping type. One or more other parameters involved in the determination of the first position may be the starting symbol of the PDSCH and the number of symbols allocated for the PDSCH in the slot.
DMRS additional position and maximum length: The numbers of positions at which the DMRS is transmitted is determined by the DMRS additional position. Tables 7.4.1.1.2-3/4 in reference [1] provide the number of positions at which the DMRS is transmitted for a given PDSCH allocation. At each position, l_{DMRS}=1 or 2 symbols comprising DMRS REs are found—the value of l_{DMRS}, i.e., length of the DMRS, is partly determined by the value maxLength in the DMRS configuration. If the value of maxLength is configured as 1, l_{DMRS} may only take a value of 1. If the value of maxLength is configured as 2, l_{DMRS} may take a value of 1 or 2 and the exact value is indicated via a lower layer, e.g., the physical, PHY, layer. If the length of DMRS is 1, it is called a single-symbol DMRS and if the length is 2, it is called a double-symbol DMRS. The length of the DMRS may also be referred to as the number of front-load symbols of the DMRS.
DMRS type: The number of REs and indices of resource elements in a symbol that comprises a DMRS are determined by the DMRS type. The DMRS type may also influence the values of some of the parameters above.

The above parameters may also be applicable in the PUSCH. In the case of the PUCCH or the PDCCH, a different set of parameters may be involved. The DMRS is inserted in the time-frequency grid corresponding to each data layer or data stream. Each data stream/layer corresponds to a DMRS port. Therefore, the terms layer, stream (of data of a physical channel) and DMRS port may be used interchangeably in this description. A PDSCH is said to be transmitted on its associated DMRS ports. A DMRS port is given a port number and the position of the DMRS resource elements and the complex baseband amplitude mapped to the DMRS resource elements in the port are determined by the port number. The complex baseband amplitude that is mapped to the DMRS resource elements is typically generated by a sequence of bits (which are typically pseudo random, for example, Gold codes, a Zadoff-Chu sequence, etc.,) that is then modulated into Quadrature Phase Shift Keying, QPSK, symbols. In frequency range 2, FR2, scenarios, there may be phase-tracking reference signals, PTRS, associated with some DMRS ports and the PTRS resource elements may also be inserted in the layers corresponding to the associated DMRS ports during resource mapping. PTRS is used for tracking phase distortions at a transmitter which are prominent in FR2. The PTRS transmission may be configured via a higher layer.

FIG. 2 illustrates a block diagram of a PxSCH transmit processing until spatial precoding, and a PDSCH transmission, until it is mapped to the layers and allocated to the time-frequency grid in a slot, may comprise the following sequence of processing as illustrated in FIG. 2:
Obtaining 150 the bits from a higher layer for the one or more transport blocks, TBs, to be transmitted (with the possibility of more than one transport block depending on the number of layers), and attaching a cyclic redundancy check, CRC, to each transport block.
Optionally, segmenting 152 the transport block into code blocks and, if segmented, attaching a CRC to each segmented code block.
Coding 154, e.g., using low density parity check, LDPC, codes in the case of 3GPP 5G NR, and rate matching 156 of each code block individually according to a code rate p and a number of available data REs set for the transmission.
Concatenating 158 of the rate-matched coded blocks into a single vector forming a codeword corresponding to each transport block, and scrambling 160.
Digital modulation 162, like M-ary Quadrature Amplitude Modulation, M-QAM, of the codeword bits according to the modulation order M set for the transmission.
Mapping 164 of the one or more modulated codewords to NL layers set or provided for the transmission.
Mapping 166 the layers to the respective time-frequency grids according to the resource allocation along with the DMRS resource elements for the N_{L} DMRS ports corresponding to the N_{L} layers, as indicated at 168. Optionally, some layers may also comprise PTRS depending on network configuration.

The time-frequency grids after the resource mapping 166 comprise the time-frequency-grid-mapped layers to be transmitted and a spatial precoder may map 170 the layers to the antenna ports at the transmitter. The spatial precoding for a certain point in the time-frequency-grid may be different from the spatial precoding used for a different point in the time-frequency-grid.

The transmit processing for a PxCCH is similar, in terms of the order of some of the building blocks of the transmit processing chain, such as the transport block CRC attachment, coding, rate-matching, digital modulation, resource mapping, spatial precoding, etc. The details of the processing, however, may differ.

The DMRS and the associated physical channel are precoded and the precoding matrix/matrices used is/are transparent to the receiver, i.e., the receiver does not know (and does not need to know) the precoding and it estimates the effective channel between the DMRS ports and the receiving ports at the receiver with the transmitted DMRS.

The functionality of each of the above mentioned variables in the DMRS configuration is now briefly discussed.

### DMRS Ports

As described earlier, each DMRS port corresponds to a data layer transmitted. Therefore, for a PxxCH transmission comprising NL layers, there are N_{L} DMRS ports associated with it. In this description, the transmission of a PxxCH on one or more DMRS ports may mean that the PxxCH transmission or a part, i.e., one or more data layers/streams, of the PxxCH transmission is/are associated with the DMRS ports. The DMRS ports are numbered as follows for PUSCH and PDSCH (see reference [1]):
1000 to 1007 for DMRS configuration type 1 of PDSCH and 0 to 7 for DMRS configuration type 1 of PUSCH
1000 to 1011 for DMRS configuration type 2 of PDSCH and 0 to 11 for DMRS configuration type 2 of PUSCH

Depending on the port number, each port may be classified into a specific code-division-multiplexing, CDM, group (see reference [1]). There are 2 CDM groups in configuration type 1 numbers 0 and 1, and 3 CDM groups in configuration type 2 numbered 0, 1 and 2. The positions of the resource elements in the time-frequency grid occupied by ports belonging to the same CDM group are the same. The positions of the resource elements in the time-frequency grid occupied by two different DMRS ports belonging to two different CDM groups are entirely distinct, i.e., there is no overlap in the positions of the resource elements in the time-frequency grid for two different DMRS ports belonging to two different CDM groups. Therefore, the DMRS resource element positions in two different CDM groups are time and/or frequency division multiplexed, TDMed and/or FDMed. A sequence of complex values is generated from a QPSK modulation of pseudo-random sequences and then mapped to the DMRS resource elements. Within a CDM group, the base-sequence of complex values used for each port is the same, but the final value mapped to a resource element in a given port is determined by an orthogonal cover code, OCC—the value from the base-sequence of complex values corresponding to the resource element is multiplied by +1 or −1 based on the port number and the resource element position in the time-frequency grid. By this method, the sequence of complex amplitudes mapped to the resource elements in a given port within a CDM group is orthogonalized with the sequence of complex amplitudes mapped to any other port within the same CDM group. The complex amplitude determination for the various DMRS ports are provided in detail in the 3GPP 5G NR specifications (see reference [1]). In the following, the resource element positions for various DMRS configurations, the use of the OCC in multiplexing the ports, the DMRS density, etc. are described.

### DMRS Configuration Type and Allocation

The DMRS configuration type determines the density of DMRS allocation in the frequency domain. In particular, DMRS configuration type 1 occupies 50% and DMRS configuration type 2 uses 33⅓% of the REs of the OFDM symbols carrying DMRS. In other words, for configuration type 1, every 2^{nd} RE is used to carry DMRS, while in configuration type 2 every 3^{rd} pair of REs are allocated to DMRS. The orthogonal Cover Code, OCC, is used for the code-division-multiplexing of the ports within a given CDM group. The OCC is a sequence of entries comprising +1 and/or −1 that is multiplied with the DMRS sequence of complex baseband amplitudes. FIG. 3A and FIG. 3B illustrate example allocations of a DMRS for configuration type 1, for the case of a single and as double symbol DMRS. A slot of a subframe of the physical resource grid used for the transmission is shown which includes 14 OFDM symbols and 12 subcarriers. The REs occupied by a DMRS are labeled “D”. FIG. 3A illustrates an example allocation of a DMRS for configuration type 1, for the case of a single symbol DMRS in which the DMRS occupies in the 3^{rd} symbol of the slot every second subcarrier staring with subcarrier 1. FIG. 3B illustrates an example allocation of a DMRS for configuration type 1, for the case of a double symbol DMRS in which the DMRS occupies in the 3rd and 4^{th} symbols of the slot at every second subcarrier staring with subcarrier 1.

FIG. 4A and FIG. 4B illustrate example allocations of a DMRS for configuration type 2, for the case of a single and as double symbol DMRS. Like in FIG. 3A or FIG. 3B, a slot of a subframe of the physical resource grid used for the transmission is shown which includes 14 OFDM symbols and 12 subcarriers. FIG. 4A illustrates an example allocation of a DMRS for configuration type 2, for the case of a single symbol DMRS in which the DMRS occupies in the 3rd symbol of the slot the 1^{st} and 2^{nd} subcarriers and the 7^{th} and 8^{th} subcarriers. FIG. 4BA illustrates an example allocation of a DMRS for configuration type 2, for the case of a double symbol DMRS in which the DMRS occupies in the 3^{rd} and 4^{th} symbols of the slot the 1^{st} and 2^{nd} subcarriers and the 7^{th} and 8^{th} subcarriers.

FIGS. 5A-5D show sample configuration types 1 for a single symbol DMRS (see FIG. 3A) and for the case where four antenna ports are multiplexed, namely antenna port 1000 of the PDSCH DMRS (see FIG. 5A), antenna port 1001 of the PDSCH DMRS (see FIG. 5B), antenna port 1002 of the PDSCH DMRS (see FIG. 5C), and antenna port 1003 of the PDSCH DMRS (see FIG. 5D). The ‘+’ and ‘−’ mentioned in the DMRS resource elements denote the orthogonal cover code entry (+1 or −1) that is applied/mapped to said DMRS resource element. Here, antenna ports 1000 and 1001 use CDM group 0, while antenna ports 1002 and 1003 use CDM group 1 and are frequency multiplexed with antenna ports 1000 and 1001.

If additional ports are to be multiplexed in configuration type 1, which comprises only 2 CDM groups, an additional symbol is used for the OCC to orthogonalize the one or more extra ports added to a CDM group. FIG. 6 shows an example DMRS allocation used in the case of configuration type 1 with 8 ports and a double symbol DMRS. For configuration type 2, up to 12 DMRS ports may be supported. A total of 3 CDM groups are available in configuration type 2-CDM groups 0, 1 and 2. Each CDM group may support up to 2 ports with a single symbol and up to 4 ports with a double symbol. An example allocation of type 2, double symbol DMRS with 12 ports is shown in FIG. 7.

### PXSCH Mapping Type

The mapping type used for PDSCH or PUSCH may affect the time-domain allocation of DMRS symbols. For the PDSCH, when mapping Type A is configured, considering an indexing of symbols in a slot starting with 0, the corresponding PDSCH symbols in the configured slot may start from symbol 0 to symbol 3. In this case, the DMRS symbol may be located either in symbol 2 or symbol 3. In the NR specifications, the higher layer parameter dmrs-TypeA-Position is used to indicate the first symbol used by DMRS. On the other hand, when mapping type B is configured, the DMRS symbol is located in the first symbol of the resource allocation. This is also referred to as front loaded DMRS configuration, because the DMRS is at the front of the transmission. This mapping type is typically used in a mini-slot-based allocation that is widely used in low latency communications. The packet sizes in such scenarios are usually smaller and they are conveyed over a reduced number of symbols within a slot. In addition, there may be more than one PDSCH/PUSCH transmission occasions in the case of mapping type B within a slot.

### DMRS Additional Positions

For a given DMRS configuration or mapping type the configuration of additional DMRS positions is possible. This is typically useful when the resource allocation occupies a wide range of symbols. For the channel to be tracked over a wider array of symbols, DMRS in additional positions that are spread across the allocated symbols of the PDxCH/PUxCH may be entailed. The number of additional DMRS symbols together with their respective positions is configured via the higher layer parameter dmrs-AdditionalPosition and is determined based on the duration of the transmission.

Lookup tables are presented in the 3GPP Technical Specifications, TS, 38.211 (see reference [1])—for single and double symbol DMRS configurations together with mapping types A and B-that mention the additional positions of the DMRS for a given resource allocation of PDSCH or PUSCH.

DMRS with Transform Precoding and Overlap of DMRS with Data and Symbols

If an RE is assigned to a DMRS, it is typically not assigned with any other data or signal. This means that if a certain position in a time-frequency grid, a resource element, RE, is assigned for DMRS in any of the ports, then no other signal or data is assigned to that position in the time-frequency grid in any of the other ports. In the case of DFT-s-OFDM, the data resource elements that are mapped to each OFDM symbol are transform-precoded, i.e., DFT-spread, before they are mapped. If a symbol comprises of DMRS resource elements, then there is no data or any other signal included in the symbol, i.e., no data or any other signal is included in the resource elements that do not carry DMRS in the symbol. Since a low peak-to-average power ratio, PAPR, sequence—specified in Section 5.2.2 of reference [1]—is used for DMRS with DFT-s-OFDM, multiplexing the DMRS with data is avoided as it may compromise the low-PAPR property.

### DMRS Configuration Indication

The DMRS configuration for a certain channel is provided to the UE via the radio resource control, RRC, layer of the protocol stack by a network entity or node. FIG. 8 and FIG. 9 illustrate an example of the RRC configuration of a DMRS for a PDSCH and of a DMRS for a PUSCH, respectively (see reference [6]). With the parameters indicated in FIG. 8 and FIG. 9 and some more parameters provided via the downlink control information, DCI, such as port numbers, number of CDM groups without data and the number of front loaded symbols (single or double), the DMRS allocation is determined. The DMRS sequence, on the other hand, is determined by one or more of the following parameters for a given physical layer channel: one or more scrambling IDs, one or more cell IDs, a PUSCH identity, a number of symbols per slot, one or more hopping IDs, etc.

### Physical Layer Channels and Transmission Configuration Indication

### Physical Downlink Control Channel, PDCCH

The PDCCH is configured at the Radio Resource Control, RRC, layer level by a base station or gNodeB, gNB. The gNB transmits the one or more PDCCHs on one or more Control Resource Sets, CORESETs, that are configured at a RRC level. A CORESET is a set of resources in the time-frequency grid carrying control information. A CORESET comprises N_{RB}^{CORESET} resource blocks in the frequency domain, as given by the higher layer parameter frequencyDomainResources and N_{symb}^{CORESET}∈{1,2,3} symbols in the time domain, as given by the higher layer parameter duration. The UE may be configured with up to 3 CORESETs per bandwidth part, BWP, per serving cell (see reference [1]).

Each CORESET comprises of one or more control channel elements, CCEs. Each control channel element comprises 6 resource element groups, REGs, where each resource element group equals one resource block in one OFDM symbol. REGs within a CORESET are numbered in increasing order in a time-first manner, starting with 0 for the first OFDM symbol and the lowest-numbered resource block in the control resource set (see reference [1]). Each CORESET is associated with a CCE-to-REG mapping. The CCE-to-REG mapping for a CORESET may be interleaved or non-interleaved and is described by REG bundles as provided in reference [1]. An REG bundle may comprise 2, 3 or 6 REGs.

A PDCCH carrying a downlink control information, DCI, for one or more of the following purposes may be transmitted on one or more CCEs:
scheduling of the physical downlink shared channel or the physical uplink shared channel or the NR/LTE sidelink channel,
providing a slot format indication,
transmitting a power control command,
cancelling of a UL transmission,
providing a power saving information notification,
providing soft resources availability notification, among others.

The number of CCEs used for a PDCCH is indicated by the aggregation level. If a PDCCH has an aggregation level of 4, the PDCCH is transmitted on 4 CCEs. The possible values for the aggregation level are 1, 2, 4, 8 and 16 (see reference [1]). A DCI of aggregation level L comprises L continuously numbered CCEs, and the CCEs are mapped on a number of REGs on a CORESET. The type of CCE-to-REG mapping used in a CORESET—interleaved or non-interleaved—and details regarding the mapping are provided in the corresponding CORESET configuration (see reference [6]). It is noted that the terms PDCCH and DCI may be used interchangeably in this disclosure. Both terms refer to a downlink control channel information obtained via the physical layer.

The UE performs blind decoding of a set of PDCCH candidates transmitted on the CORESETs configured to the UE. The UE searches for PDCCH candidates on configured search space sets on the CORESETs. A search space set that the UE searches for PDCCH candidates on a CORESET is provided via the higher layer configuration of the search space, SS, set. There may be two types of SS sets:
common search space, CSS, sets—commonly monitored by a group of UEs in the cell, and
UE-specific search space, USS, sets—monitored by an individual UE.

The categorization of the search space into one of the two types above is achieved by setting the parameter searchSpace Type in SearchSpace to common or ue-Specific. Each search space set is associated with a CORESET—the ID of the associated CORESET is provided in controlResourceSetId in the higher layer configuration SearchSpace. The UE may be configured with up to 10 search space sets per DL BWP in a serving cell, i.e., there may be a maximum of 40 configured search space sets in a serving cell, and each configured search space set is provided with a SearchSpaceId. Each search space set comprises the number of PDCCH candidates the UE has to blindly decode in search of a PDCCH/DCI in a given aggregation level. The blind decoding process involves the unscrambling of the cyclic redundancy check, CRC, bits of each PDCCH candidate in every search space with various radio network temporary identifier, RNTI, values that they may be possibly scrambled with and performing the CRC check to verify if the CCEs corresponding to the PDCCH candidate comprises a valid DCI according to the DCI formats to be monitored for a given search space.

The DCI format determines the utility/purpose of a given DCI. The DCI format identifiers and the corresponding purpose they are used for are provided in reference [2]. Each DCI comprises one or more fields in it, and each field provides a certain information that is associated with the utility/purpose of the DCI. For a DCI of given format, the interpretation of the message in the DCI for the given purpose is performed based on the fields present in it-whose size and/or presence are determined by fixed specification directives and/or higher layer indication.

### Physical Uplink Shared Channel, PUSCH

The one or more PUSCH transmissions from a UE may be dynamically scheduled by a network node via an UL grant indicated in the PDCCH or may be semi-persistently or statically scheduled with the higher layer configured grant configuredGrantConfig. The configured grant Type 1 PUSCH transmission is semi-statically configured to operate upon the reception of a higher layer parameter configuredGrantConfig including rrc-ConfiguredUplinkGrant without the detection of an UL grant in the PDCCH. The configured grant Type 2 PUSCH transmission is semi-persistently scheduled by an UL grant in a valid activation PDCCH (see reference [3]) after the reception of the higher layer parameter configuredGrantConfig not including rrc-ConfiguredUplinkGrant (see reference [4]).

The mode of transmission of the PUSCH is determined by the higher layer parameter txConfig. The parameter may be set to either codebook or nonCodebook or it may not be configured. When the PUSCH is scheduled via the PDCCH, two different downlink control information, DCI, formats may be used in the scheduling-PDCCH—DCI format 0_0 or DCI format 0_1. The codebook-based PUSCH transmission and the non-codebook-based PUSCH transmission are scheduled using DCI format 0_1 (see reference [4]), when scheduled via the PDCCH. When scheduling the PUSCH using DCI format 0_1, the gNB indicates the ports from which the UE has to transmit via the SRS resource indicator, SRI. The SRI field in DCI format 0_1 indicates one or more SRS resources from a codebook SRS resource set or from a non-codebook SRS resource set, which means that the UE transmits the PUSCH via the SRS ports associated with the SRS resources indicated via the SRI.

In the case of codebook-based-PUSCH, the precoding of the ports for the PUSCH transmission is indicated via the scheduling PDCCH. In the non-codebook case, the precoding of the ports for the PUSCH transmission is either predetermined or left for UE implementation (see references [1] to [4]). It is also possible that the PUSCH scheduled via a PDCCH using DCI format 0_1 may not contain an SRI field—this may happen when the SRS resource set that the SRI uses to indicate the ports to transmit the PUSCH from contains only one SRS resource. For a codebook-based PUSCH or for a non-codebook-based PUSCH scheduled via a higher layer grant, the SRI is indicated by the scheduling grant, when applicable. When txConfig is not configured, the UE does not expect the PUSCH to be scheduled using DCI format 0_1. When the PUSCH is scheduled with DCI format 0_0, the UE uses a single port for the PUSCH transmission (see reference [4]).

In the case of a codebook-based PUSCH (see reference [4]), the UE determines its PUSCH transmission precoder based on the SRI, the transmit precoding matrix index, TPMI, and the transmission rank, where the SRI, TPMI and the transmission rank are given by fields of the SRS resource indicator and precoding information and number of layers in the scheduling DCI, as described in clause 7.3.1.1.2 and 7.3.1.1.3 of reference [2], or by a higher layer configuration of the PUSCH grant. In the case of a non-codebook-based PUSCH, the UE is not provided with any explicit indication of a precoding.

The beam direction or spatial relation of the PUSCH is determined from the beam direction or spatial relation of an SRS or a PUCCH resource depending on the mode of PUSCH transmission:
A codebook- or non-codebook-based PUSCH transmission is indicated with an SRS resource. The UE sounds the UL channel with SRS resources, which are configured specifically for the codebook/non-codebook transmission mode, and the gNB, in return, schedules the PUSCH via the indication of an SRS resource. The UE, thereby, transmits the PUSCH from the same ports from which the SRS resource was transmitted and uses the same beam direction or spatial relation for the transmission of the PUSCH as for the transmission of the SRS resource.
When the UE is scheduled by DCI format 0_0, a single-port PUSCH, the spatial relation used for the transmission of the PUSCH is the same as that used for the transmission of the PUCCH resource with the lowest ID in the currently active UL bandwidth part, BWP.

The pathloss reference RS, which is configured or indicated via a higher layer, is used in the power control settings of the PUSCH to determine the pathloss estimate for the transmission of the PUSCH (see reference [3]). The pathloss reference RS for the PUSCH is determined in different ways for different modes of PUSCH transmission. The PUSCH is configured with a list of pathloss reference RSs in the PUSCH-PathlossReferenceRS information elements, IEs, and in most cases, it uses the list to obtain the pathloss reference RS.
For a codebook- or non-codebook-based PUSCH transmission scheduled by the PDCCH, the pathloss reference RS is configured in the SRI-PUSCH-PowerControl IEs (see reference [6]). SRI stands for SRS Resource Indicator, and these IEs contain the power control settings for the PUSCH such as the ID of a PUSCH-pathlossReferenceRS, alpha values (pathloss compensation factor) and the closed loop power control index. The mapping between the PUSCH-pathlossReferenceRS IEs and the SRI-PUSCH-PowerControl IEs may be modified using Medium Access Control-Control Element, MAC-CE, messages (see reference [3]). The SRS resource indicator, SRI, mentioned for the codebook or non-codebook PUSCH transmission maps to a SRI-PUSCH-PowerControl IE that provides these power control settings. When there is no SRI field in the scheduling PDCCH, the UE uses the SRI-PUSCH-PowerControl whose ID value is set to 0.
For a single-port PUSCH, which is scheduled by the PDCCH via DCI format 0_0, the pathloss reference RS is obtained from the same PUCCH resource that it obtains the spatial relation from.
When the PUSCH is scheduled by a higher layer grant, the pathloss reference RS to be used is indicated via a pathlossReferenceIndex that points to a PUSCH-pathlossReferenceRS IE or is obtained from the SRI-PUSCH-PowerControl whose ID value is set to 0 when there is no SRS resource indicator field.

### Physical Uplink Control Channel, PUCCH

The physical uplink control channel, PUCCH, carries control information such as channel state information, CSI, feedback, the hybrid automatic repeat request, HARQ, acknowledgement, ACK, or negative acknowledgement, NACK, for a physical downlink shared channel, PDSCH transmission, and scheduling requests, SRs. A unit of the PUCCH that carries uplink control information, UCI, is a PUCCH resource. A PUCCH resource is an RRC configured space in a certain format, e.g., format 0, 1, 2, 3, in a certain UL bandwidth-part, BWP (see references [3] and [6]). The UL-BWP is a contiguous frequency domain space on which the UE transmits in the UL. The UE may be configured with up to 4 UL-BWPs, and it transmits on only one of them at a given time instance. The UL BWP on which the UE transmits is the active UL BWP. The UE is configured with four PUCCH resource sets via RRC. The PUCCH resources in a given PUCCH resource set may carry a specified load of uplink control channel information as indicated by the higher-layer parameter maxPayloadMinus1 (see reference [3]). The other parameters in the PUCCH resource configuration indicate the frequency hopping characteristics of the PUCCH resource.

The PUCCH resources that may carry the various types of the uplink control information, UCI-HARQ ACK/NACK for a PDSCH transmission, SRs and DL CSI feedback—are configured and indicated as follows (see references [2], [3] and [6]):
The PUCCH resource that carries the HARQ ACK/NACK for a PDSCH is indicated by a PUCCH resource indicator field in the PDCCH that schedules the PDSCH. The mapping from the PUCCH resource indicator field contained in the PDCCH to a PUCCH resource in the four PUCCH resource sets is configured by the gNB via RRC as described in reference [3].
The SRs are configured via RRC in the SchedulingRequestConfig IE and other associated IEs, and each scheduling request configuration includes the IDs of one or more PUCCH resources that carry the SRs. The transmission settings of the SRs, like periodicity, offset, etc., are configured at the RRC level.
The CSI report configuration received via RRC at the UE includes the IDs of the one or more PUCCH resources that carry the semi-persistent and/or periodic CSI reports in the UL. The transmission settings of the same are provided in the CSI report configurations. The activation or deactivation of the semi-persistent CSI reports is handled via MAC-CE messages. The configuration of the CSI reports via RRC is enough for the transmission of periodic CSI reports.

### Downlink Transmission Configuration Indication, DL-TCI

The physical downlink control channel, PDCCH, and the physical downlink shared channel, PDSCH, carry DL control information, DCI, and DL data, respectively, to a UE (see references [1] to [6]. Demodulation reference signals, DMRSs, are embedded for the coherent demodulation of the PDCCH or of the PDSCH at the UE. The DMRS comprises of a set of DMRS ports. The number of DMRS ports determines the number of transmission layers contained in a PDSCH. The DMRS is used for channel estimation at the UE to coherently demodulate the PDSCH or the one or more PDCCHs. In the case of a PDCCH, one or more of them may be transmitted on a CORESET. Therefore, the DMRS for the coherent demodulation of the one or more PDCCHs on the CORESET may be embedded across the one or more PDCCHs transmitted on the CORESET.

A parameter in the transmission of the PDCCH and the PDSCH is the Transmission Configuration Indication-state, TCI-state ((see reference [4]). In 3GPP Rel. 16, the indication of how the control or the shared channel is transmitted by the gNB and what assumptions the UE needs to consider while receiving them, is done via reference signals, RSs. The indication to the UE is performed using a TCI-state information element, IE configured via RRC. A TCI-state IE, among others, comprises of the following elements:
one or more reference signals, and
for each reference signal, one or more quasi-colocation, QCL, assumptions.

The TCI-state is used to mention or indicate how to receive a PDSCH or the one or more PDCCHs transmitted on a CORESET. Applying a TCI-state to a PDSCH or CORESET implies that the DMRS ports of the PDSCH or the DMRS ports of the one or more PDCCHs transmitted on the CORESET, are assumed to be quasi-co-located with the reference signals mentioned or indicated in the TCI-state. Assuming quasi-colocation means that certain channel parameters such as Doppler shift or spread, delay spread, average delay and/or Tx beam direction are assumed to be the same for the RS mentioned in the TCI-state and the DMRS ports of the PDSCH, or the DMRS ports of the one or more PDCCHs transmitted on the CORESET. Four different QCL types may be indicated in 3GPP Rel. 16 (see reference [4]);
QCL-TypeA: {Doppler shift, Doppler spread, average delay, delay spread}
QCL-TypeB: {Doppler shift, Doppler spread}
QCL-TypeC: {Doppler shift, average delay}
QCL-TypeD: {Spatial Rx parameter}

One or more of the QCL-Info parameters are included in the TCI-state IE to provide the one or more QCL assumptions associated with the TCI-state.

For example, a TCI-state IE comprising a DL reference signal, RS, A with a QCL assumption QCL-typeA and a DL RS B with QCL-assumption QCL-TypeD is considered. Applying this TCI-state to a PDSCH or CORESET with the given quasi-colocation assumptions means that the UE may assume the same Doppler shift, Doppler spread, average delay and delay spread for the PDSCH or the one or more PDCCHs transmitted on the CORESET and for the DL RS A, and the UE may use the same spatial filter to receive the DL RS B and to receive the PDSCH or the one or more PDCCHs transmitted on the CORESET, or the Rx spatial filter to receive the one or more PDCCHs on the CORESET or to receive the PDSCH may be obtained from or be similar to that used for the reception of the DL RS B.

Usually, the TCI state that is used to schedule a PDCCH or a PDSCH contains the identifiers, IDs, of channel state information reference signals, CSI-RSs, or synchronization signal blocks, SSBs, along with the QCL assumptions for the reference signal. The RS in the TCI-state is usually a RS that the UE has measured before, so that it may use it as a reference to receive the DMRS of the PDCCH or PDSCH, and hence demodulate the same. The indication of a TCI-state for a CORESET or a PDSCH is performed via Medium Access Control-Control Element, MAC-CE, messages or by using the TCI-indication field or the TCI field in the downlink control information, DCI, used to schedule the PDSCH. If a PDSCH is scheduled by a DCI without a TCI field, the TCI state of the PDSCH follows that of the CORESET on which the DCI that schedules the PDSCH was received.

In FR2, where the gNB and UE establish a connection via spatially selective or directive beams, the TCI-state is used to indicate the Rx beams in which the UE may receive, i.e., the spatial filter that may be used by the UE to receive a PDSCH or one or more PDCCHs via a qcl-TypeD assumption with a CSI-RS or an SSB that the UE has received. The determination of the DL Tx beam to transmit the one or more PDCCHs or the PDSCH is performed via a beam sweeping procedure by the network node, e.g., the gNB. In a beam sweeping procedure, the gNB configures a set of DL RSs, like CSI-RS or SSB, via RRC for the UE to measure the set of DL RSs. Each of the configured DL RS may be transmitted with a different spatial filter, i.e., each of the configured DL RS may be transmitted in a different direction by the gNB. The UE measures each of the configured DL RS by receiving them using one or more spatial filters—the RSs may all be received with the same spatial filter or a different spatial filter may be used to receive each RS. Following the measurements, the UE sends a beam report to the gNB. The beam report comprises the indices 1≤L≤4 configured DL RSs, essentially, L DL Tx beam directions, with each beam direction resulting from the use of a specific spatial filter at the gNB, along with the received power in each of the RSs (see reference [4]). With the help of the beam report, the gNB determines one or more suitable DL Tx beam directions, i.e., one or more spatial filters for the transmission of the one or more PDCCHs and the PDSCH.

### Grouping of Channels or Resources

In 3GPP Rel. 16, multi-transmit-receive-point, multi-TRP or MTRP, transmissions that improve the reliability and robustness of the transmission were standardized. A consequence of this is the grouping of control channel resources in uplink and downlink for various purposes.

The CORESETpoolIndex is a parameter introduced in 3GPP Rel. 16 (see reference [4]) in the configuration of a CORESET. A CORESET may be associated with a value of a CORESETpoolIndex via a higher layer configuration. This parameter or index may be used to group CORESETs into different pools. The pools may be organized according to the TRPs they are associated with in the case of multi-TRP transmissions. The PDCCHs transmitted on the CORESETs configured with the same CORESETpoolIndex value may be considered to be associated with the same TRP. A CORESET belonging or associated to a CORESETpoolIndex means that the higher layer configuration of the CORESET may comprise the CORESETpoolIndex value. When a UE is configured, by the network node, with multiple CORESETpoolIndex values, the UE understands that it may receive multiple PDSCHs, possibly overlapped in time and frequency domains, scheduled by multiple PDCCHs that are received on CORESETs configured with the different CORESETpoolIndex values, i.e., CORESETs associated with different TRPs.

Similarly, PUCCH resource grouping was introduced in Rel. 16 for the update of the beam direction or spatial relation for a group of resources together in a bid to reduce latency, signaling overhead and optionally, to serve MTRP use-cases. The UE may receive a configuration of a PUCCH resource group via a higher layer, e.g., RRC, that is associated with one or more PUCCH resources (see reference [6]). Each PUCCH resource group may additionally be configured with a PUCCH resource group identifier, ID, (see reference [6]).

When a MAC-CE updating the spatial relation for one of the PUCCH resources in the group is received by the UE, the UE updates the spatial relation of all the PUCCH resources associated with the same PUCCH resource group as the one for which the spatial relation update is received.

It is noted that the information in the above section is only for enhancing the understanding of the background of the invention and, therefore, it may contain information that does not form conventional technology that is already known to a person of ordinary skill in the art.

In view of the above-described conventional technology, there remains a need for enhancements and/or improvements regarding the use of reference signals, like the DMRS.

### SUMMARY

An embodiment may have a user device, UE, for a wireless communication system, wherein the UE is configured to receive and/or transmit one or more physical channel transmissions, and wherein at least one of the physical channel transmissions is received or transmitted with a partial or full DeModulation Reference Signal, DMRS, muting, wherein
the partially muted DMRS transmission is associated with a DMRS configuration for the physical channel, and wherein a proper subset of the resources that are associated with the DMRS are muted, and
the fully muted DMRS transmission is associated with a DMRS configuration for the physical channel, and wherein all of the resources that are associated with the DMRS are muted,
   wherein a muted resource is occupied by information other than the DMRS, and wherein the said information other than the DMRS occupying a muted resource has one or more of the following:
a part of a payload of the associated physical channel transmission,
a part of a payload of a different physical channel transmission,
   wherein the UE is configured to receive for at least one transmission occasion of the physical channel transmission an indication activating DMRS muting at a certain time instant for a certain duration.

Another embodiment may have a user device, UE, for a wireless communication system, wherein the UE is configured to receive and/or transmit one or more physical channel transmissions, wherein at least one of the physical channel transmissions is received or transmitted without any associated DeModulation Reference Signal, DMRS, wherein the UE is configured to receive for at least one transmission occasion of the physical channel transmission an indication activating DMRS muting at a certain time instant for a certain duration.

Another embodiment may have a network entity for a wireless communication system, the wireless communication system having one or more user devices, UEs, wherein the network entity is configured to receive and/or transmit one or more physical channel transmissions from and/or to a UE, and wherein one or more of the physical channel transmissions are received or transmitted with a partial or full DeModulation Reference Signal, DMRS, muting, wherein
the partially muted DMRS transmission is associated with a DMRS configuration for the physical channel, and wherein a proper subset of the resources that are associated with the DMRS are muted, and
the fully muted DMRS transmission is associated with a DMRS configuration for the physical channel, and wherein all of the resources that are associated with the DMRS are muted,
   wherein a muted resource is occupied by information other than the DMRS, and wherein the said information other than the DMRS occupying a muted resource has one or more of the following:
a part of a payload of the associated physical channel transmission,
a part of a payload of a different physical channel transmission,
wherein the UE is configured to receive for at least one transmission occasion of the physical channel transmission an indication activating DMRS muting at a certain time instant for a certain duration.

Still another embodiment may have a network entity for a wireless communication system, the wireless communication system having one or more user devices, UEs, wherein the network entity is configured to receive and/or transmit one or more physical channel transmissions from and/or to a UE, and wherein one or more of the physical channel transmissions are received or transmitted without any associated DeModulation Reference Signal, DMRS, wherein the UE is configured to receive for at least one transmission occasion of the physical channel transmission an indication activating DMRS muting at a certain time instant for a certain duration.

Another embodiment may have a wireless communication system, having one or more user devices, UEs, in accordance with the invention as mentioned above and/or one or more network entities in accordance with the invention as mentioned above.

According to another embodiment, a method for operating a user device, UE, for a wireless communication system may have the steps of: receiving and/or transmitting, by the UE, one or more physical channel transmissions, wherein at least one of the physical channel transmissions are received or transmitted with a partial or full DeModulation Reference Signal, DMRS, muting, wherein
the partially muted DMRS transmission is associated with a DMRS configuration for the physical channel, and wherein a proper subset of the resources that are associated with the DMRS are muted, and
the fully muted DMRS transmission is associated with a DMRS configuration for the physical channel, and wherein all of the resources that are associated with the DMRS are muted,
   wherein a muted resource is occupied by information other than the DMRS, and wherein the said information other than the DMRS occupying a muted resource has one or more of the following:
a part of a payload of the associated physical channel transmission,
a part of a payload of a different physical channel transmission,
   wherein the UE receives for at least one transmission occasion of the physical channel transmission an indication activating DMRS muting at a certain time instant for a certain duration.

According to another embodiment, a method for operating a user device, UE, for a wireless communication system, may have the steps of: receiving and/or transmitting, by the UE, one or more physical channel transmissions, wherein at least one of the physical channel transmissions is received or transmitted without any associated DeModulation Reference Signal, DMRS, wherein the UE receives for at least one transmission occasion of the physical channel transmission an indication activating DMRS muting at a certain time instant for a certain duration.

According to another embodiment, a method for operating a network entity for a wireless communication system, the wireless communication system having one or more user devices, UEs, may have the steps of: receiving and/or transmitting, by the network entity, one or more physical channel transmissions from and/or to a UE, wherein one or more of the physical channel transmissions are received or transmitted with a partial or full DeModulation Reference Signal, DMRS, muting, wherein
the partially muted DMRS transmission is associated with a DMRS configuration for the physical channel, and wherein a proper subset of the resources that are associated with the DMRS are muted, and
the fully muted DMRS transmission is associated with a DMRS configuration for the physical channel, and wherein all of the resources that are associated with the DMRS are muted,
   wherein a muted resource is occupied by information other than the DMRS, and wherein the said information other than the DMRS occupying a muted resource has one or more of the following:
a part of a payload of the associated physical channel transmission,
a part of a payload of a different physical channel transmission,
   wherein the UE receives for at least one transmission occasion of the physical channel transmission an indication activating DMRS muting at a certain time instant for a certain duration.

According to another embodiment, a method for operating a network entity for a wireless communication system, the wireless communication system having one or more user devices, UEs, may have the steps of: receiving and/or transmitting, by the network entity, one or more physical channel transmissions from and/or to a UE, wherein one or more of the physical channel transmissions are received or transmitted without any associated DeModulation Reference Signal, DMRS, wherein the UE receives for at least one transmission occasion of the physical channel transmission an indication activating DMRS muting at a certain time instant for a certain duration.

Another embodiment may have a non-transitory computer program product having a computer readable medium storing instructions which, when executed on a computer, perform the above-mentioned methods in accordance with the invention.

### BRIEF DESCRIPTION OF THE DRAWINGS

Embodiments of the present invention are now described in further detail with reference to the accompanying drawings, in which:

FIGS. 1A-1B are schematic representations of an example of a terrestrial wireless network;

FIG. 2 illustrates a block diagram of a PxSCH transmit processing until spatial precoding;

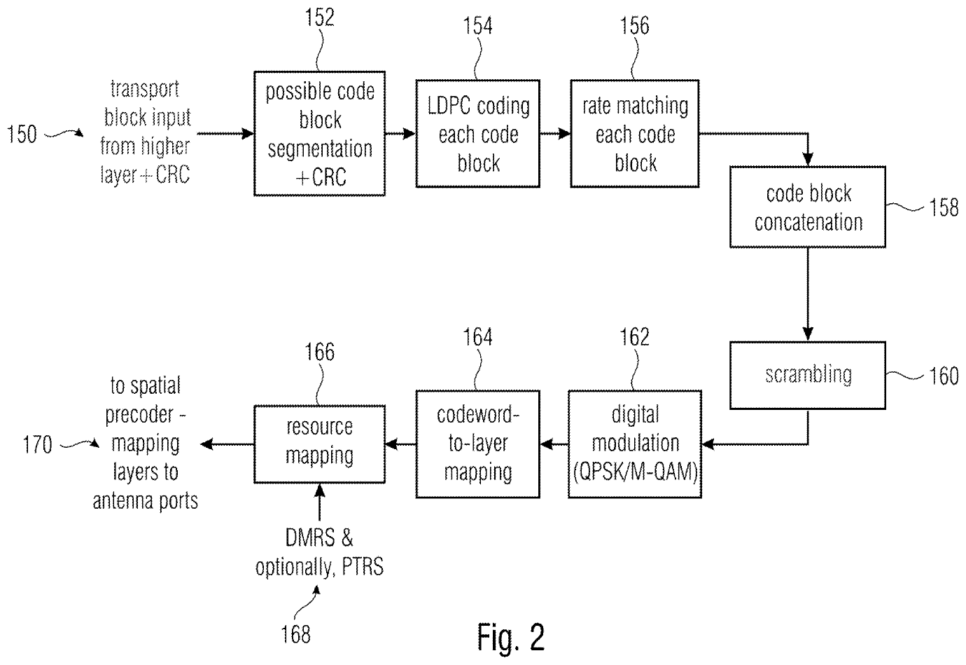

FIGS. 3A-3B illustrate example allocations of a DMRS for configuration type 1, for the case of a single symbol DMRS (FIG. 3A) and for the case of a double symbol DMRS (FIG. 3B);

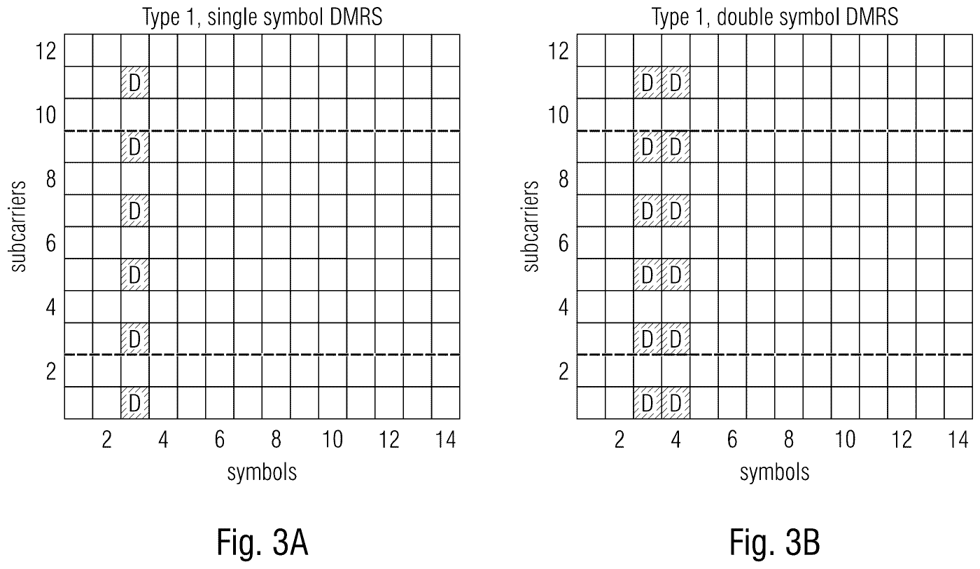

FIGS. 4A-4B illustrate example allocations of a DMRS for configuration type 2, for the case of a single symbol DMRS (FIG. 4A) and for the case of a double symbol DMRS (FIG. 4B);

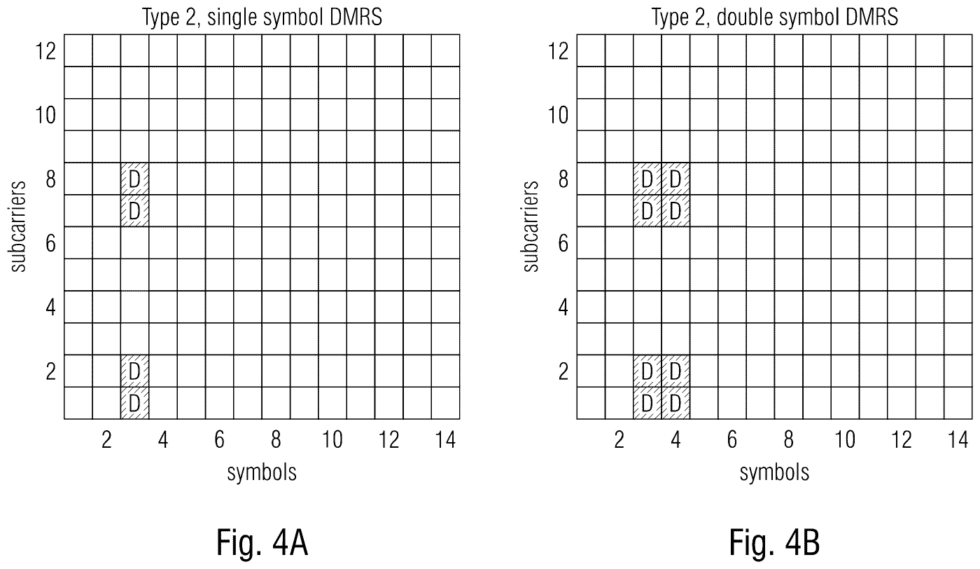

FIGS. 5A-5D show examples for a DMRS configuration type 1, single symbol DMRS with antenna ports 1000, 1001 in CDM Group 0 and antenna ports 1002, 1003 in CDM Group 1, wherein FIGS. 5A-5D illustrate the configurations for antenna ports 1000,1001, 1002 and 1003, respectively;

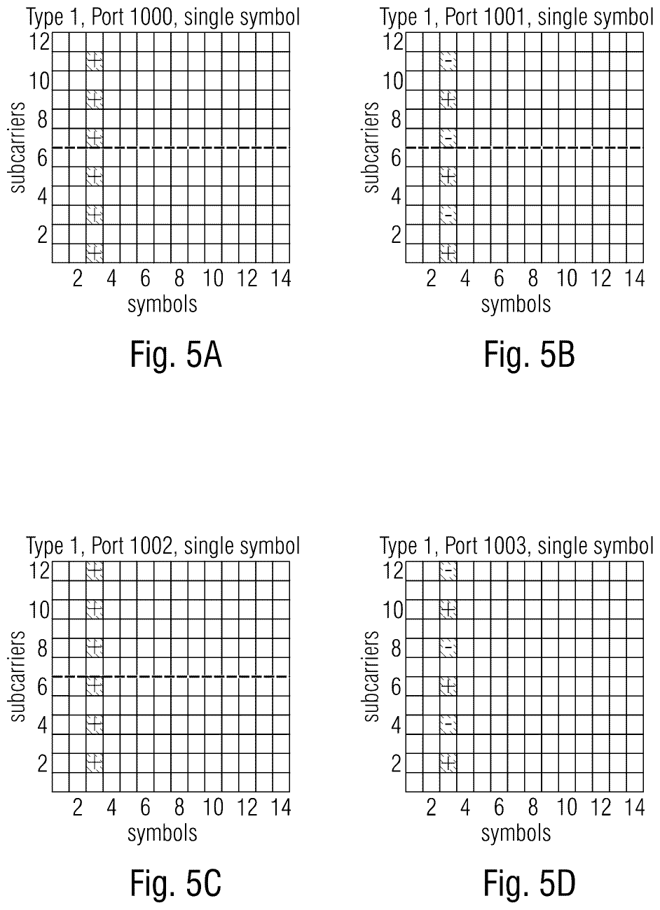

FIG. 6 shows an example for a DMRS configuration type 1, double symbol DMRS for 8 antenna ports with at least 2 DMRS symbols to support 8 port transmissions;

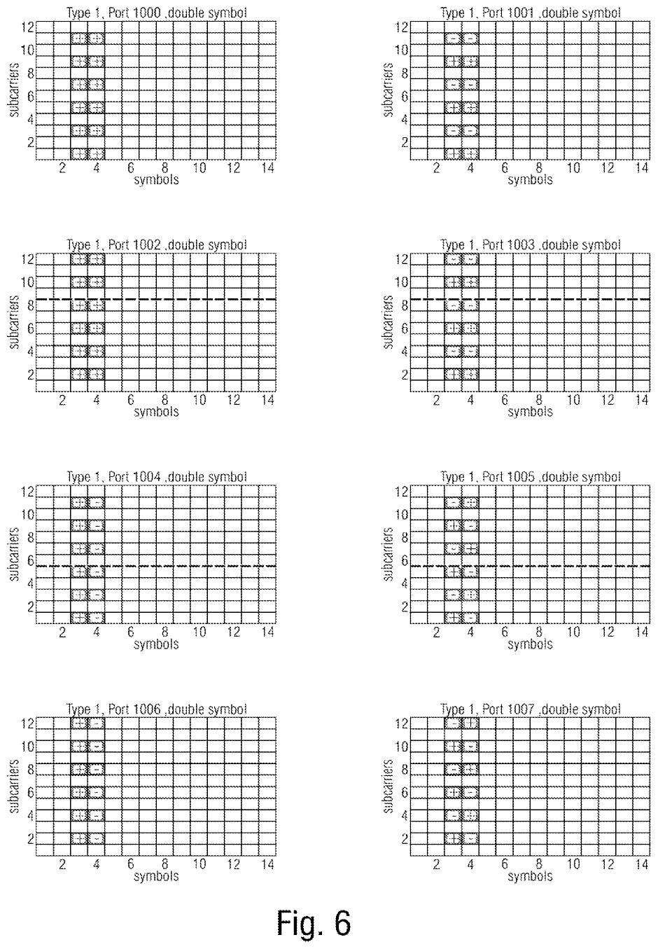

FIG. 7 shows an example for a DMRS configuration type 2, double symbol DMRS for 12 antenna ports with at least 2 DMRS symbols to support 12 port transmissions;

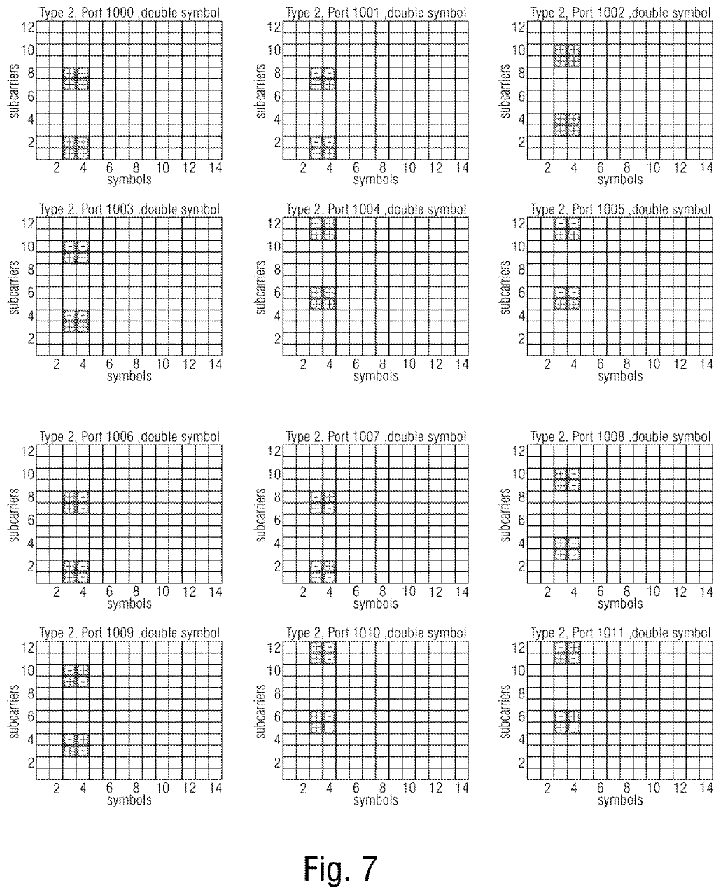

FIG. 8 illustrates an example of the RRC configuration of a DMRS for a PDSCH;

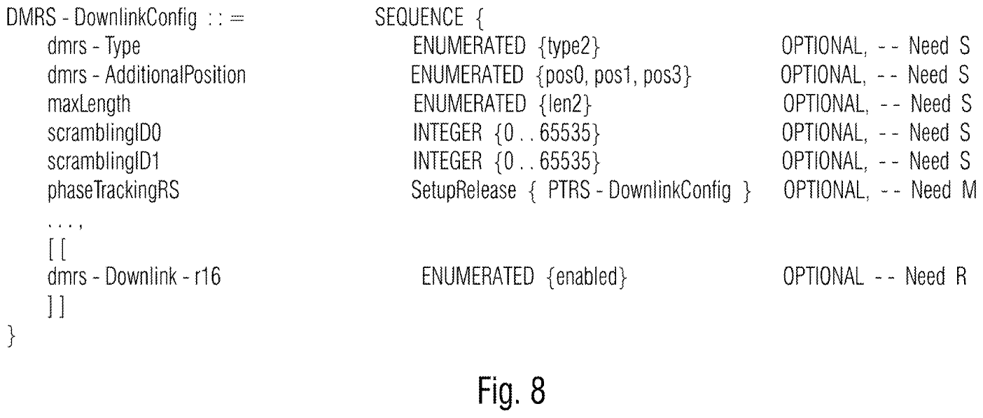

FIG. 9 illustrates an example of the RRC configuration of a DMRS for a PUSCH;

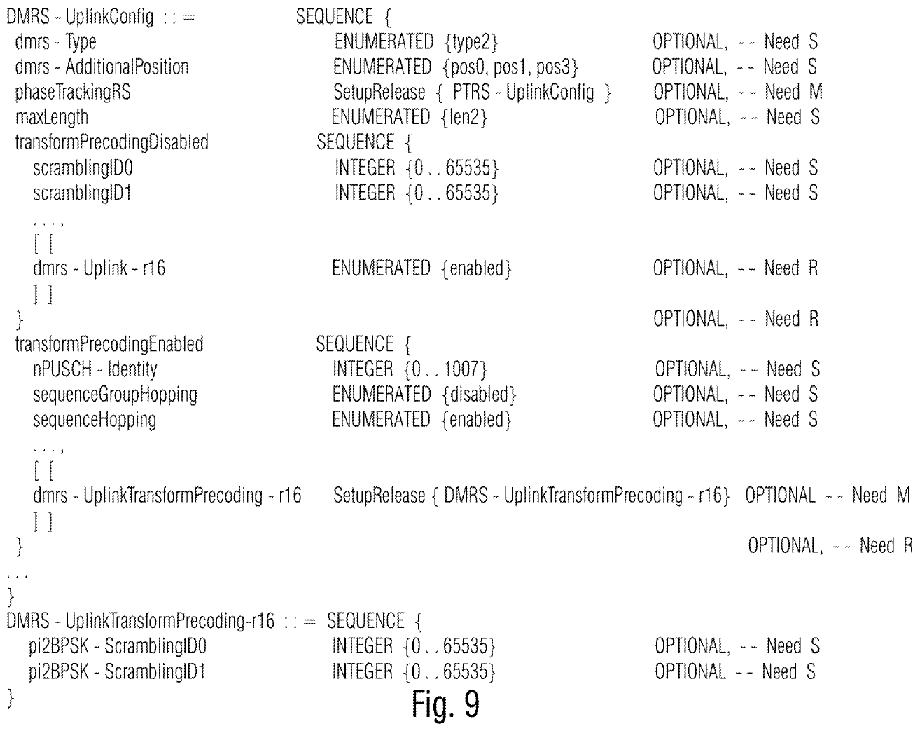

FIG. 10 is a schematic representation of a wireless communication system including a transmitter, like a base station, and one or more receivers, like user devices or UEs, capable of operating in accordance with embodiments of the present invention;

FIG. 11 illustrates a user device and a network entity in accordance with embodiments of the present invention;

FIGS. 12A-12C illustrate examples for the dynamic, semi-persistent and the semi-static DMRS muting in accordance with embodiments of the present invention; and

FIG. 13 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

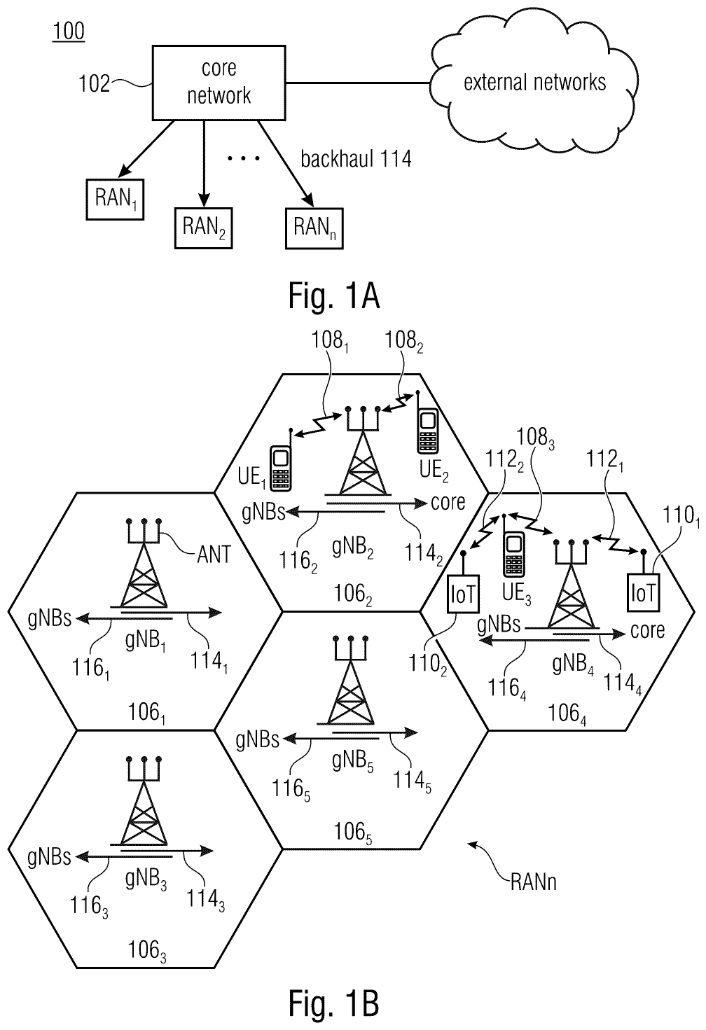

In a wireless communication system or network, like the one described above with reference to FIGS. 1A and 1B, which, for example, may be a 5G or NR wireless communication network, the 5G NR physical layer is designed to be scalable by seamlessly incorporating additional features needed to deal with a widening range of scenarios and applications desirable for the 5G ecosystem and beyond. It has great flexibility in configuring the waveform for multiplexing in frequency and time, while being robust to highly frequency- and time-selective fading channels. This robustness is achieved, inter alia, by providing the DMRs, more specifically, by associating the DMRS with each transmission received at the UE or transmitted by the UE so that the radio channel may be estimated and decoding the transmission at the receiver is improved despite varying channel conditions. However, this robustness comes at the prize, i.e., it is bought by the necessity to associate each transmission with the DMRS.

However, as new scenarios and applications are encountered where the channel conditions may be rather static, e.g., in frequency and in time, over several transmissions, the existing configuration for the DMRS turns out to be not flexible enough to reduce the overhead in order to maximize the throughput. For example, it has been found that a wireless channel in satellite communication scenarios may have very low frequency and time selectivity, and, therefore, a reduced DMRS density is sufficient for the necessary channel estimation for decoding the transmitted data. However, in accordance with conventional approaches, as described above, even with the least possible DMRS density possible by a conventional configuration, still DMRSs need to be associated with the transmission. Moreover, in the case of DFT-s-OFDM transmission, which may be applicable for DL transmissions as well, a conventional DMRS configuration provides even less flexibility for DMRS overhead reduction, because, if a symbol in the radio frame has even a single DMRS resource element, the whole symbol is blocked for data.

The present invention addresses the above-summarized issues by providing enhancements and improvements in the use of DMRSs when receiving or sending a transmission by a user device in a wireless communication network. More specifically, the present invention address the issue of DeModulation Reference Signal, DMRS, overhead reduction. As described above, DMRS, which is used in the coherent demodulation of various physical layer channels, is transmitted along with every occasion of a physical channel transmission, however, it has been found that there are several use cases that do not require such overhead of the DMRS. Embodiments of the present invention allow for a DMRS overhead reduction through partial or full DMRS muting which may be applied for various use cases, like low-mobility and low-scattering-environment use-cases. In other words, other than in conventional approaches, a user device in accordance with embodiments of the present invention, which receives and/or transmits one or more physical channel transmissions, is not to expect a DMRS for every occasion of a physical channel transmission. Likewise, a network entity, like a base station or gNB, which schedules one or more physical channel transmissions for one or more user devices, performs the scheduling such that the scheduled user device does not to expect a DMRS for every occasion of the physical channel transmission, or a lower DMRS density is sufficient.

Thus, other than conventional approaches which, as described above, do not allow for a complete muting or removal of DMRS, even with the least possible DMRS density possible by a conventional configuration, embodiments are provided which allow for a complete or partial muting or removal of DMRS from a transmission.

The inventive approach may, in general, be referred to as DMRS muting, and, in accordance with embodiments, allocated DMRS REs according to the PHY-layer and/or higher layer configuration and/or an indication of the DMRS may be muted via network indication and/or specification directives. The DMRS muting may be described as full or partial based on the number of DMRS resource elements that are occupied by one or more other channels or signals or that are left blank. If all the DMRS resource elements according to the DMRS configuration are muted, i.e., left blank or occupied by other signals or channels, then it is a full or complete DMRS muting.

In accordance with embodiments, in the case of full DMRS muting, there may not be any associated DMRS configuration. If only a proper subset of the DMRS resource elements according to the DMRS configuration are muted, this may be referred to as partial muting.

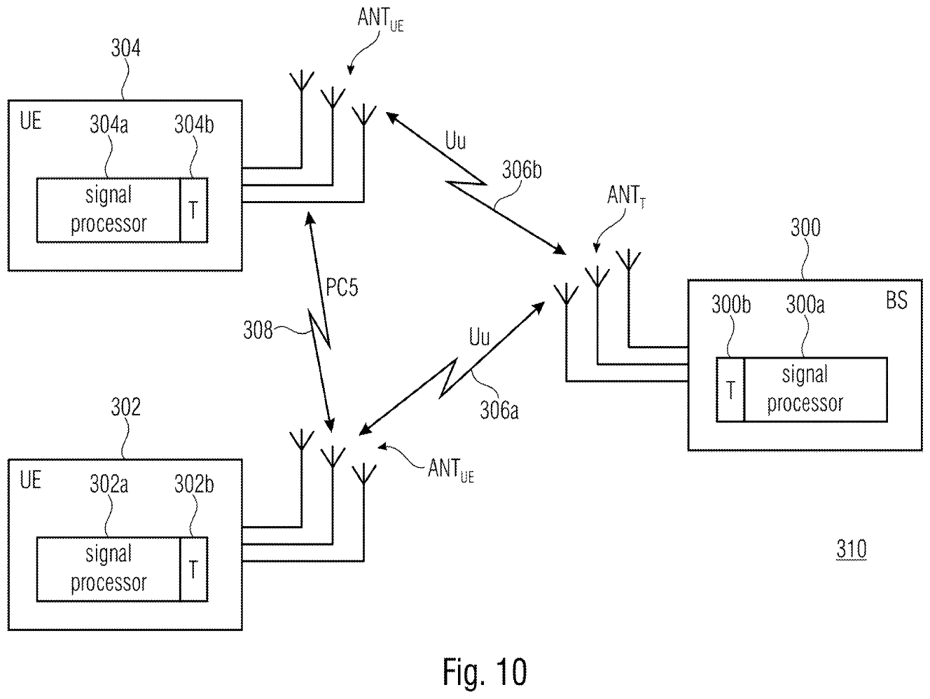

Embodiments of the present invention may be implemented in a wireless communication system as depicted in FIG. 1B including base stations and users, like mobile terminals or IoT devices or industrial IoT (IIoT) devices. FIG. 10 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 10, the one or more UEs 302, 304 of FIG. 10, and the base station 300 of FIG. 10 may operate in accordance with the inventive teachings described herein.

### User Device

The present invention provides a user device, UE, for a wireless communication system, like a 3^{rd} Generation Partnership Project, 3GPP, system,
wherein the UE is to receive and/or transmit one or more physical channel transmissions, and
wherein one or more of the physical channel transmissions are received or transmitted without any associated DeModulation Reference Signal, DMRS, or with a partial or full DMRS muting.

In accordance with embodiments,
partial DMRS muting during a transmission occasion of a physical channel comprises muting a proper subset of resources that are associated with a DMRS configuration for said transmission occasion, a muted resource being occupied by information other than the DMRS or being left blank, and
full DMRS muting during a transmission occasion comprises muting all resources that are associated with a DMRS configuration, a muted resource being occupied by information other than the DMRS or being left blank.

In accordance with embodiments, the UE is
configured or preconfigured with an absence or a presence of partial or full DMRS during a certain physical channel transmission occasion, and/or
to receive an indication of an absence or a presence of partial or full DMRS during a certain physical channel transmission occasion, e.g., from a network node of the wireless communication system via a physical, PHY, layer, like an indication in a downlink control information, DCI, or via a media access control, MAC, layer, like an indication in a MAC control element, MAC-CE, or via a higher layer, like an indication in a radio resource control, RRC, layer.

In accordance with embodiments, the UE is
configured or preconfigured with an absence of associated DMRS or a presence of partial or full DMRS muting during a certain physical channel transmission occasion, and/or
to receive an indication of an absence of associated DMRS or a presence of partial or full DMRS muting during a certain physical channel transmission occasion, e.g., from a network node of the wireless communication system via a physical, PHY, layer, like an indication in a downlink control information, DCI, or via a media access control, MAC, layer, like an indication in a MAC control element, MAC-CE, or via a higher layer, like an indication in a radio resource control, RRC, layer.

In accordance with embodiments,
in case of partial or full DMRS muting, a physical channel transmission to be received or transmitted by the UE comprises a partially or fully muted DMRS transmission,
the partially muted DMRS transmission is associated with a DMRS configuration for the physical channel, and wherein a proper subset of the resources that are associated with the DMRS are muted, and
the fully muted DMRS transmission is
   associated with a DMRS configuration for the physical channel, and wherein all of the resources that are associated with the DMRS are muted, or
   a transmission that is not associated with a DMRS configuration for the physical channel, and
      wherein a muted resource is occupied by information other than the DMRS or is left blank, e.g., is transmitted with zero power.

In accordance with embodiments, the said information other than the DMRS occupying a muted resource comprises one or more of the following:
a part of a payload of the associated physical channel transmission,
a part of a payload of a different physical channel transmission,
any physical signal other than the DMRS.

In accordance with embodiments, the UE is to receive
for each transmission occasion of the physical channel transmission, an indication whether DMRS muting is performed or not, e.g., for implementing dynamic muting, or
for a certain number of transmission occasions of the physical channel transmission, an indication that DMRS muting is performed or an indication of a DMRS muting pattern across the transmission occasions, e.g., for implementing semi-persistent muting,
an indication activating DMRS muting at a certain time instant for a certain duration, e.g., until receiving a signaling deactivating the DMRS muting or modifying the DMRS muting, e.g., for implementing semi-static muting.

### DCI-Based Muting

In accordance with embodiments, the UE is to receive a downlink control information, DCI, that indicates an activation or a deactivation of DMRS muting for one or more physical channels at one or more physical channel transmission occasions.

In accordance with embodiments,
the UE is configured to allow DMRS muting, e.g., via a higher layer signaling, like a radio resource control, RRC, signaling, or the UE is preconfigured to allow DMRS muting, e.g., by one or more fixed specification directives known at the UE, like the 3GPP specification, and
the UE is to activate DMRS muting in response to the DCI only if the UE is configured or preconfigured to allow DMRS muting.

In accordance with embodiments, for the activation or deactivation of DMRS muting, the DCI is to signal
an activation of a DMRS transmission for a physical layer transmission so that the physical layer transmission is performed in association with a DMRS with no DMRS muting being performed or wherein no DMRS muting is performed, and a deactivation of a DMRS transmission for a physical layer transmission so that the physical layer transmission is performed with partial or full DMRS muting of the associated DMRS, or
an activation of DMRS muting for a physical layer transmission so that the physical layer transmission is performed with partial or full muting of the associated DMRS, and a deactivation of DMRS muting for a physical layer transmission so that the physical layer transmission is performed in association with a DMRS with no DMRS muting being performed or wherein no DMRS muting is performed.

In accordance with embodiments, the activation or deactivation of DMRS muting for a physical channel transmission is indicated in a first DCI or in a second DCI, the first DCI being a DCI used for scheduling said physical channel transmission, and the second DCI being a DCI separate from a DCI used for scheduling said physical channel transmission.

In accordance with embodiments, the first DCI indicates the activation or deactivation of DMRS muting for one or more one of the following physical channels:
one or more physical downlink shared channels, PDSCHs, or one or more physical uplink shared channels, PUSCHs, scheduled by the first DCI,
all PDSCH transmission occasions or all PUSCH transmission occasions associated with a Hybrid Automatic Repeat Request, HARQ, identifier, or associated with a HARQ process number indicated in the first DCI,
all PDSCH transmission occasions or all PUSCH transmission occasions associated with an identical value for at least one of the following allocation parameters: number of symbols, number of subcarriers or resource blocks, number of layers,
one or more physical uplink control channel, PUCCH, resources that carry an acknowledgement or negative acknowledgement, like a HARQ-ACK or a HARQ-NACK, for one or more PDSCHs scheduled by the first DCI,
one or more PUCCH resources that are indicated in a PUCCH resource indicator field of the first DCI,
a control resource set, CORESET, associated with the first DCI, and, thereby, with one or more PDCCHs associated with the CORESET,
one or more CORESETs associated with the same CORESET pool index value as the CORESET associated with the first DCI, and, thereby, with one or more PDCCHs associated with the CORESETs,
all CORESETs in one or more the active bandwidth parts, BWPs, in the uplink, UL, and/or the downlink, DL.

In accordance with embodiments, for implementing semi-persistent muting, the DCI indicates the activation or deactivation of DMRS muting for a plurality of physical channels and/or for a plurality of transmission occasions.

In accordance with embodiments,
the DCI indicates the activation or deactivation of DMRS muting for one or more of the following physical channels:
   one or more PDSCHs and/or PUSCHs, up to n≥1 transmission occasions after reception of the DCI,
   one or more PDCCHs and/or PUCCHs, up to n≥1 transmission occasions after reception of the DCI,
   one or more PDSCHs and/or PUSCHs, up to n≥1 transmission occasions after reception of the DCI, and one or more associated PUCCHs and/or PDCCHs, and
the value of n may be higher-layer-configured or fixed in a specification known at the UE.

In accordance with embodiments, the one or more associated PUCCHs may be one of the following:
one or more PUCCH resources that carry the acknowledgement or negative acknowledgement, HARQ-ACK/NACK, for said PDSCH(s),
one or more PUCCH resources indicated by said DCI,
one or more PUCCH resources associated with a preconfigured or indicated value of an index such as a CORESET pool index or a PUCCH resource group index, or
all or a subset of UE dedicated PUCCH resources in a carrier component.

In accordance with embodiments, the one or more associated PDCCHs may be one of the following:
all PDCCH(s) in the active DL BWP of a CC,
all PDCCH(s) associated with either UE-specific search space sets or common search space sets in the active DL BWP of a CC,
one or more PDCCHs scheduling said PDSCH(s) or PUSCH(s),
one or more PDCCHs associated with a CORESET on which the DCI indicating the DMRS muting activation or deactivation is transmitted,
one or more PDCCHs associated with one or more CORESETs configured with the same CORESET pool index value as the CORESET on which the DCI indicating the DMRS muting activation or deactivation is transmitted,
one or more PDCCHs associated with a CORESET on which the DCI scheduling the PDSCH(s) or PUSCH(s) is transmitted, or
one or more PDCCH(s) associated with one or more CORESETs configured with the same CORESET pool index value as the CORESET on which the DCI scheduling the PDSCH(s) or PUSCH(s) is transmitted.

In accordance with embodiments, the DCI indicating the activation of a DMRS muting for one or more repetitions of a physical uplink or downlink shared channel transmission applies to
one or more PUCCHs carrying a HARQ-ACK or a HARQ-NACK for a PDSCH,
one or more PUCCHs indicated in a PUCCH resource indicator in the DCI, or
one or more PDCCHs associated with one or more CORESETs that are associated with the DCI.

In accordance with embodiments, the physical channels for which DMRS muting is allowed is indicated by one or more of the following:
one or more fixed specification directives known at the UE, or
a configuration of the UE obtained, e.g., by higher layer signaling.

In accordance with embodiments, the DCI comprises
a DCI having a conventional DCI format, like DCI format 1_1 or DCI format 0_1, wherein an existing field of the conventional DCI format, like the Antenna Ports field, includes one or more reserved codepoints or values, wherein one or more of the reserved codepoints or values are used to indicate the activation or deactivation of DMRS muting, or
a DCI having a conventional DCI format, like DCI format 1_1 or DCI format 0_1, including an additional field used to indicate the activation or deactivation of DMRS muting.

### MAC-CE-Based Muting

In accordance with embodiments, the UE is to receive a MAC control element, MAC-CE, that indicates an activation or a deactivation of DMRS muting for one or more physical channels at one or more physical channel transmission occasions.

In accordance with embodiments,
the UE is configured to allow DMRS muting, e.g., via a higher layer signaling, like a radio resource control, RRC, signaling, or the UE is preconfigured to allow DMRS muting, e.g., by one or more fixed specification directives known at the UE, like the 3GPP specification, and
the UE is to activate DMRS muting in response to the MAC-CE only if the UE is configured or preconfigured to allow DMRS muting.

In accordance with embodiments,
the MAC-CE indicates the activation or deactivation of DMRS muting for one or more one of the following physical channels:
   one or more PDSCHs and/or PUSCHs, up to n≥1 transmission occasions after reception of the MAC-CE,
   one or more PDCCHs and/or PUCCHs, up to n≥1 transmission occasions after reception of the MAC-CE,
   one or more PDSCHs and/or PUSCHs, up to n≥1 transmission occasions after reception of the MAC-CE, and the associated PUCCH(s) and/or PDCCH(s),
the value of n may be higher-layer-configured or may be fixed in a specification known at the UE.

In accordance with embodiments, the one or more associated PUCCH(s) may be one of the following:
one or more PUCCH resources that carry the acknowledgement or negative acknowledgement, HARQ-ACK/NACK, for said PDSCH(s),
one or more PUCCH resources associated with a preconfigured or indicated value of an index such as a CORESET pool index or a PUCCH resource group index, or
all or a subset of UE dedicated PUCCH resource(s) in a CC.

In accordance with embodiments, the one or more associated PDCCHs may be one of the following:
all PDCCH(s) (and hence, the associated CORESET(s)) in the active DL BWP of a CC,
all PDCCH(s) associated with either UE-specific search space sets or common search space sets in the active DL BWP of a CC, one or more PDCCHs scheduling said PDSCH(s) or PUSCH(s),
one or more PDCCHs associated with a CORESET on which the DCI scheduling the PDSCH(s) or PUSCH(s) is transmitted, or
one or more PDCCHs associated with one or more CORESETs configured with the same CORESET pool index value as the CORESET on which the DCI scheduling the PDSCH(s) or PUSCH(s) is transmitted.

In accordance with embodiments, the physical channels for which DMRS muting is allowed are indicated by one or more of the following:
one or more fixed specification directives known at the UE, or
a configuration of the UE obtained, e.g., by higher layer signaling, or
one or more fields in the MAC-CE.

### Muting Via RRC or a Combination of Layers

In accordance with embodiments, the UE is to receive a RRC layer signaling that indicates an activation or a deactivation of DMRS muting for one or more physical channels.

In accordance with embodiments, the UE is to receive an RRC parameter that indicates an activation of DMRS muting for one or more physical channels, and, responsive to the activation of DMRS muting, the UE is to transmit or receive a physical channel with partial or full DMRS muting at one or more transmission occasions.

In accordance with embodiments,
the UE is preconfigured, e.g., by one or more fixed specification directives known at the UE, like the 3GPP specification, with one or more DMRS muting settings, and
the UE is to activate or deactivate one or more of the DMRS muting settings responsive to a lower layer signaling, like a PHY-layer signaling, or responsive to a higher layer signaling, like an RRC, signaling.

In accordance with embodiments, a DMRS muting setting indicates one or more of the following:
the physical channels that may be subject to DMRS muting,
a pattern of DMRS muting.

### Muting with Repeated Transmissions

In accordance with embodiments, the UE is to receive a signaling that indicates an activation of DMRS muting for one or more repetitions of a physical channel associated with the same transport block.

In accordance with embodiments, the UE is to receive a scheduling of the physical channel repetitions, the scheduling indicating that at least one of the physical channel repetitions is performed with partial or full DMRS muting, wherein the indication of the partial or full DMRS muting may be provided via the lower layer signaling and/or via a higher layer signaling.

In accordance with embodiments, the scheduling of the physical channel repetitions cause the UE to perform a first instance of the transmission channel without DMRS muting and to perform one or more subsequent instances or all of the other instances of transmission of the channel with partial or full DMRS muting.

In accordance with embodiments, the scheduling of the physical channel repetitions cause the UE to perform a first instance of transmission of the channel without DMRS muting and to perform one or more subsequent instances or all of the other instances of transmission of the channel with partial or full DMRS muting.

### Muting Patterns

In accordance with embodiments, the UE is to receive a signaling that indicates an activation or a deactivation of DMRS muting for one or more physical channels at one or more physical channel transmission occasions, wherein the signaling is associated with a DMRS muting pattern, the DMRS muting pattern indicating DMRS muting in the time-domain for one or more physical channel transmission occasions and/or DMRS muting in the frequency-domain for a set of subcarriers associated with muted resource elements.

In accordance with embodiments, the UE is to receive a signaling that indicates an activation or a deactivation of DMRS muting for one or more physical channels at one or more physical channel transmission occasions, wherein the signaling is associated with a DMRS muting pattern, the DMRS muting pattern indicating DMRS muting in the time-domain for one or more physical channel transmission occasions and/or DMRS muting in the frequency-domain for a set of subcarriers associated with resource elements configured for a DMRS transmission. Stated differently, the subcarriers have the DMRS resource elements that are muted.

In accordance with embodiments, the DMRS muting pattern in the time-domain comprises a series of one or more DMRS activations and/or deactivations applied to at least two or more physical channel transmission occasions, wherein the physical channel transmission occasions may be consecutive or non-consecutive in time.

In accordance with embodiments, the DMRS muting pattern in the frequency-domain comprises a series of one or more DMRS activations and/or deactivations across the frequency domain, e.g., by muting a set of subcarrier indices associated with resource elements configured for a DMRS transmission.

In accordance with embodiments,
the UE is preconfigured with one or more DMRS muting patterns according to one or more fixed specification directives known at the UE, like the 3GPP specification, or
the UE is configured with one or more DMRS muting patterns by a network entity of the wireless communication system via one or more of the following:
lower layer signaling, like PHY layer signaling,
higher layer signaling, like RRC layer signaling,
lower layer signaling, like PHY layer signaling, and higher layer signaling, like RRC layer signaling or MAC layer signaling.

In accordance with embodiments, for configuring one or more DMRS muting patterns by a network entity of the wireless communication system via lower layer signaling, the UE is to receive a DCI comprising an indication of the one or more DMRS muting patterns,
wherein the DCI comprises a DCI field indicating a specific DMRS muting pattern to be activated and/or deactivated, and
wherein, optionally, said DCI field may comprise a codepoint indicating that no DMRS muting pattern is to be used, or that a previously applied DMRS muting is to be deactivated.

In accordance with embodiments, for configuring one or more DMRS muting patterns by a network entity of the wireless communication system via higher layer signaling, the UE is to receive
a DMRS configuration of a physical channel via RRC layer signaling, wherein the DMRS configuration comprises a field indicating a specific DMRS muting pattern to be activated and/or deactivated, or
a MAC-CE via MAC layer signaling, wherein the MAC-CE comprises a field indicating a specific DMRS muting pattern to be activated or deactivated, wherein the activation and deactivation of DMRS muting may be indicated by the same MAC-CE message format or by two different formats of MAC-CE messages, and wherein, optionally, the MAC-CE may serve for the activation or deactivation of DMRS muting.

In accordance with embodiments, for configuring one or more DMRS muting patterns by a network entity of the wireless communication system via lower and higher layer signaling, the UE is to receive
a list of DMRS muting patterns of a physical channel via RRC layer signaling, and
a PHY-layer signaling or MAC-CE signaling, the signaling indicating
   a down-selection of one or more DMRS muting patterns from the list, of which one may be selected for application or activation via a further PHY-layer signaling or MAC-CE signaling, or
   one of the DMRS muting patterns from the list to be applied or activated.

In accordance with embodiments,
if the UE is preconfigured with one or more DMRS muting patterns, the UE is to receive a signaling for application or activation of one or more of the DMRS muting patterns,
the application or activation may be performed based on one or more of the following:
   an activation signaling from a network entity of the wireless communication system, or
   one or more transmission parameters of the associated physical channel assigned with preconfigured or fixed values, or
   a UE capability to apply or activate one of the preconfigured DMRS muting patterns to the one or more physical channels.

In accordance with embodiments, the activation signaling comprises one or more of the following:
a selection from the preconfigured DMRS muting patterns;
an index that maps to one of the preconfigured DMRS muting patterns, thereby activating or deactivating a DMRS muting pattern for one or more of the physical channels,
an ON/OFF signaling associated with one of the preconfigured DMRS muting patterns.

In accordance with embodiments, a specific one of the preconfigured DMRS muting patterns is activated for said associated physical channel only if a mapping type, a DMRS configuration and/or the like of said physical channel, have preconfigured or fixed values.

In accordance with embodiments, after receiving an activation of a DMRS muting that is associated with a DMRS muting pattern, the UE is to apply the DMRS muting pattern up to a specific number of transmission occasions for the physical channel, wherein the specific number may be a preconfigured, e.g., by one or more fixed specification directives known at the UE, like the 3GPP specification, or may be indicated, e.g., by a signaling from a network entity of the wireless communication system.
wherein, after completing a DMRS muting pattern cycle, the UE is to
   repeat the DMRS muting pattern until signaling is received that deactivates DMRS muting, or
   repeat the DMRS muting pattern until a timer is expired, wherein the said timer is started after activation of DMRS muting pattern, or
   stop applying the DMRS muting pattern.

In accordance with embodiments, the UE is to receive a DMRS muting pattern indication for a muting of DMRS across the time domain, the DMRS muting pattern indication including one or more of the following parameters:
a frequency or periodicity of the DMRS muting, wherein the frequency or periodicity of the DMRS muting indicates how often the DMRS muting pattern is applied to the one or more physical channels, wherein the frequency or periodicity may be expressed in terms of number of slots or a number of transmission occasions or a number of symbols or in milliseconds,
a frequency or periodicity of the DMRS muting, wherein the frequency or periodicity of the DMRS muting indicates how often the DMRS muting pattern is applied to the one or more physical channels, wherein the periodicity may be expressed in terms of a number of slots or a number of transmission occasions or a number of symbols or in milliseconds, and the frequency may be expressed in terms of number of slots per unit time or number of transmission occasions per unit time or number of symbols per unit time,
an offset value, wherein the offset value indicates an offset for the activation or application of the DMRS muting pattern, which may be expressed in terms of a number of slots or a number of transmission occasions or a number of symbols or in milliseconds,
a starting slot or subframe or frame number for the application of the DMRS muting,
a bitmap indicating the DMRS muting pattern for a certain number of transmission occasions, wherein, if a position in the bitmap for a certain transmission occasion has a first value, DMRS is muted for the certain transmission occasion, and, if the position in the bitmap for the certain transmission occasion has a second value, DMRS is not muted for the certain transmission occasion,
a duration of the DMRS muting pattern.

In accordance with embodiments, the UE is to receive a DMRS muting pattern indication for a muting of DMRS resource elements, REs, across the frequency domain, the DMRS muting pattern indication including one or more of the following parameters:
a bitmap indicating a DMRS muting pattern per resource block, wherein the bitmap has a length according to a number of subcarriers in a resource block, wherein, if a position in the bitmap for a certain resource element has a first value, DMRS is muted for the certain resource element, and, if the position in the bitmap for the certain resource element has a second value, DMRS is not muted for the certain resource element,
a bitmap indicating a DMRS muting pattern per resource block, wherein the bitmap has a length according to a number of subcarriers corresponding to a DMRS within a resource block, wherein, if a position in the bitmap for a certain DMRS resource element has a first value, DMRS is muted for the certain DMRS resource element, and, if the position in the bitmap for the DMRS certain resource element has a second value, DMRS is not muted for the DMRS certain resource element,
an offset value, the offset value indicating a starting subcarrier number, e.g., from subcarrier number 0 in every resource block, from which DMRS resource elements are muted.

In accordance with embodiments, the DMRS muting pattern is indicated by a single bit, and the UE is to receive the single bit via a DCI message or via a MAC-CE message, wherein a presence or absence of a field in the DCI message or in the MAC-CE message that carries the single bit implicitly indicates an activation or deactivation of DMRS muting, and wherein a value of the single bit indicates the DMRS muting pattern.

In accordance with embodiments, the UE is preconfigured or configured with one or more DMRS muting patterns to be applied to a set of physical channel repetitions, and
wherein, responsive to a scheduling of a physical channel with repetition, the UE is to receive one or more DCI messages or MAC-CE messages that indicate one or more of the preconfigured or configured DMRS muting patterns to be applied.

In accordance with embodiments, the UE is to
receive a scheduling of a physical channel with repetition, wherein at least one of the physical channel repetitions is performed with DMRS muting, and
responsive to the scheduling of the physical channel with repetition, the UE is to receive, via PHY layer signaling, an indication of the DMRS muting pattern for the physical channel repetitions.

In accordance with embodiments, the UE is to receive a DCI comprising a field carrying an indication of the DMRS muting pattern, wherein the DCI field may carry a bit string, wherein
a size of the bit string specifies a number of transmission occasions for which the DMRS muting pattern is configured, or
the bit string maps to an index or an identification of a preconfigured or configured DMRS muting pattern.

In accordance with embodiments, responsive to the scheduling of a physical channel with DMRS muting, the UE is to receive, from a network entity of the wireless communication system, an indication of a number of transmission occasions for which DMRS muting is performed.

In accordance with embodiments, the UE is to receive a DCI comprising a field carrying an indication of the DMRS muting pattern, wherein the DCI field may carry a bit string, wherein a size of the bit string specifies a number of transmission occasions for which the DMRS muting applied is configured.

In accordance with embodiments, the UE is to receive a DCI comprising a field carrying an indication of the DMRS muting pattern, wherein the DCI field may carry a bit string, wherein a size of the bit string specifies a number of transmission occasions for which the DMRS muting applied/performed.

In accordance with embodiments, responsive to the scheduling of a physical channel with DMRS muting, the UE is to receive, from a network entity of the wireless communication system, an indication of a frequency of DMRS muting for the physical channel.

In accordance with embodiments, the UE is to receive a DCI or MAC-CE comprising a field carrying an indication of the DMRS muting pattern, wherein the field may carry/denote a value Y indicating that DMRS muting is applied for every Y-th transmission occasion. The value ‘Y’ may also be indicated indirectly (i.e., not carried in the DCI/MAC-CE). For example, an index in the DCI/MAC-CE may denote the value Y via a mapping defined in the specifications.

### Partial Muting in the Time Domain

In accordance with embodiments,
for receiving or transmitting a physical channel, the UE is provided with a DMRS configuration via a higher layer that comprises the following two parameters that determine the time-domain allocation of the DMRS:
   additional number of DMRS positions and
   number of front-load symbols, and
the UE is preconfigured or configured with,
   a first value for additional number of DMRS positions for the physical channel, and/or
   two front-load symbols for the associated DMRS for the physical channel, and
      in case of partial DMRS muting, for realizing the partial DMRS muting in the time-domain, the UE is to receive from a network entity of the wireless communication system an indication that a DMRS for the physical channel is applied with one or more of the following settings:
a second value for the additional number of DMRS positions which is less than the first value,
the number of front-load symbols is one.

In accordance with embodiments, the UE is
preconfigured or configured with a default value for the second value, or
to receive an indication from a network entity of the wireless communication system, e.g., via a DCI or MAC-CE, of the second value to be applied, or
preconfigured or configured with a list of second values, and the UE is to receive an indication from a network entity of the wireless communication system, e.g., via a DCI or MAC-CE, which second value from the list is to be applied, or
preconfigured or configured maximum second value, and the UE is to use a second value less than said maximum value.

### Partial Muting in the Frequency Domain

In accordance with embodiments,
the UE is to receive or transmit a physical channel that is associated with a DMRS configuration, and
   in case of partial DMRS muting, for realizing the partial DMRS muting in the frequency-domain, the UE is to receive from a network entity of the wireless communication system an indication of a proper subset of resource elements associated with the DMRS configuration that are to be muted.

In accordance with embodiments, the UE is to receive an indication that DMRS resource elements with certain subcarrier indices are to be muted or are to be left unmuted.

### PxxCH Transmissions with DMRS Ports Indicated in the DCI

In accordance with embodiments, the UE is to
receive or transmit a physical channel with partial or full DMRS muting, and
receive a scheduling of the physical channel that indicates the DMRS ports that are associated with the physical channel.

In accordance with embodiments, for receiving the physical channel, the UE is to obtain a channel information from an earlier physical channel transmission performed without DMRS muting, wherein the channel information may include at least one of the following: channel coefficients, Doppler spread, delay spread.

### PxxCH Transmissions without DMRS Ports Indicated in the DCI

In accordance with embodiments, the UE is to
receive or transmit a physical channel with partial or full DMRS muting, and
receive a DCI scheduling of the physical channel that does not indicate the DMRS ports that are associated with the physical channel, and
   wherein the UE is to associate the physical channel with DMRS ports that are indicated in a DCI received before reception of the DCI scheduling the physical channel.

In accordance with embodiments, the DCI in which the DMRS port indication is contained comprises one or more of the following:
in case the physical channel is a PDSCH, the DCI comprising the DMRS port indication is the latest DCI that schedules or indicates at least one PDSCH transmission, and that is received before the reception of the physical channel or reception the DCI scheduling of the physical channel,
in case the physical channel is a PUSCH, the DCI comprising the DMRS port indication is the latest DCI that schedules or indicates at least one PUSCH transmission, and is received before the transmission of physical channel or the reception of the DCI scheduling of the physical channel,
in case the physical channel is a PDSCH, the DCI comprising the DMRS port indication is the latest DCI that schedules at least one PDSCH transmission with partial or no DMRS muting, and is received before the reception of the physical channel or reception the DCI scheduling of the physical channel,
in case the physical channel is a PUSCH, the DCI comprising the DMRS port indication is the latest DCI that schedules at least one PUSCH transmission with partial or no DMRS muting, and is received before the transmission of the physical channel or reception the DCI scheduling of the physical channel.

In accordance with embodiments, for receiving the physical channel, the UE is to obtain channel state information or channel information for resources of a given layer or data stream in the physical layer transmission with DMRS muting from resources corresponding to the same DMRS port in a previous physical layer transmission.

### PxxCH Transmissions without DMRS Configuration

In accordance with embodiments, in case the UE is to receive or transmit a physical channel with full DMRS muting wherein there is no associated DMRS configuration with the physical channel, the UE is also to receive at least one additional physical channel configuration that is associated with a DMRS configuration.

In accordance with embodiments, the UE is to obtain one or more of the following information from the additional physical channel:
the DMRS ports indication associated with the additional physical channel,
the channel information associated with the DMRS ports of the additional physical channel.

### Overriding or Ignoring DMRS Muting

In accordance with embodiments, when the UE is indicated by a network node to receive or transmit a physical channel in one or more transmission occasions with partial or full DMRS muting, the physical channel being associated with a DMRS configuration, the UE receives or transmits said transmission occasions of said physical channel without DMRS muting.

In accordance with embodiments, the one or more transmission occasions include one or more of the following:
when a number of resource elements for said channel without DMRS is not an integer multiple of a product of number of subcarriers per resource block, the number of resource blocks, the number of symbols and the number of layers or data streams for any valid values for said resource allocation variables,
when an indication for DMRS muting is overridden by a signaling, like a MAC-CE or a DCI.

In accordance with embodiments, the UE is to report to a network entity of the wireless communication system, one or more of the following parameters:
a capability to override a DMRS muting indication,
a capability to override a muting indication during a transmission occasion.

### Time Domain Resource Allocation

In accordance with embodiments, the UE is to receive a DCI scheduling of a physical channel with repetition, and wherein the DCI indicates one or more time allocation parameters, like a starting position of the transmission or a length of the transmission in terms of a number of symbols, that is applicable only in a proper subset of the transmission occasions.

In accordance with embodiments,
if the scheduling of the physical channel with repetition begins in a transmission occasion without DMRS muting, the one or more time allocation parameters apply fully only to the transmission occasions wherein the transmission is performed without DMRS muting, or
if the scheduling of the physical channel with repetition does not begin in a transmission occasion without DMRS muting, at least one of the time-domain allocation parameters does not apply, e.g., a starting symbol for a transmission may be the same for all repetitions while a length value/vector may be different, or
the one or more time allocation parameters apply fully only to the transmission occasions where the transmission is performed without DMRS muting, and wherein only a proper subset or none of the one or more time-domain allocation parameters apply to the transmission occasions where the transmission is performed with DMRS muting.

### Transport Block Size Determination

In accordance with embodiments, when the UE is to receive or transmit a physical channel with full DMRS muting, the UE is to determine the total number of available resource elements per physical resource block for a physical channel as follows:

$${N}_{RE}^{′} = {N}_{sc}^{RB} \cdot {N}_{symb}^{sh} - {N}_{DMRS}^{PRB} - {N}_{oh}^{PRB}$$

with
N_{sc}^{RB} a number of subcarriers in a physical resource block,
N_{symb}^{sh} a number of symbols of the physical channel allocation within the slot,
N_{DMRS}^{PRB} a number of REs for DM-RS per PRB in the scheduled duration including the overhead of the DM-RS CDM groups without data, and
Nₒₕ^{PRB} an overhead configured by a higher layer parameter, and
wherein the UE is to set N_{DMRS}^{PRB} to zero.

In accordance with embodiments, when the UE is to receive or transmit a physical channel with partial DMRS muting, the UE is to determine the total number of available resource elements per physical resource block for a physical channel as follows:

$${N}_{RE}^{′} = {N}_{sc}^{RB} \cdot {N}_{symb}^{sh} - {N}_{DMRS}^{PRB} - {N}_{oh}^{PRB}$$

with

N_{sc}^{RB} a number of subcarriers in a physical resource block,
N_{symb}^{sh} a number of symbols of the physical channel allocation within the slot,
N_{DMRS}^{PRB} a number of REs for DM-RS per PRB in the scheduled duration including the overhead of the DM-RS CDM groups without data, and

Nₒₕ^{PRB} an overhead configured by a higher layer parameter, and Noh
wherein the UE is to set N_{DMRS}^{PRB} to a value that is less than the number of DMRS resource elements allocated via at least one of the following:
   a higher layer DMRS configuration,
   a DCI/MAC-CE signaling regarding the number of front-load symbols, DMRS ports indication, a PTRS-DMRS ports association.

In accordance with embodiments, the UE is to compute a total number of REs allocated for the physical channel N_{RE} as follows:
N_{RE}=min (Z, N′_{RE})·n_{PRB} where Z may take one of the following values: 156, 162, 164, 168, and n_{PRB} is the total number of allocated PRBs for the UE, or
N_{RE}=N′_{RE}·n_{PRB}

### Consistent Parameters

In accordance with embodiments, the UE is to obtain, for a first transmission occasion of a physical channel with fully or partially muted DMRS, channel information from a second transmission occasion of a physical channel previous to the first one,
wherein the first transmission occasion is a current physical channel transmission, and the second transmission occasion is a reference physical channel transmission, the current and reference physical channel comprising a PDCCH or a PDSCH, and
wherein the UE uses the channel information from the reference physical channel transmission for the current physical channel transmission.

In accordance with embodiments, one or more of the following parameters are identical for the current PDSCH transmission and the reference PDSCH transmissions:
one or more transmission configuration indication, TCI, states,
one or more physical resource block bundling parameters,
a modulation and coding scheme, MCS,
DMRS ports,
one or more precoding parameters.

In accordance with embodiments, the reference PDSCH transmission comprises one of the following:
the latest PDSCH transmission received by the UE before the current PDSCH transmission,
the latest PDSCH transmission received by the UE before the current PDSCH transmission with the same HARQ process or transport block ID,
the PDSCH transmission scheduled by a DCI associated with the same CORESET pool index as the DCI scheduling the current PDSCH.

In accordance with embodiments, the physical channel comprises a PDCCH and the UE is to receive the current PDCCH transmission on a CORESET with DMRS muting, and wherein one or more of the following parameters are identical for the reference PDCCH transmission and the current PDCCH transmission:
one or more transmission configuration indication, TCI, states,
an associated CORESET,
a precoding granularity, e.g., REG bundle level, wideband, subband, and the like,
an aggregation level,
an associated search space set.

In accordance with embodiments, the reference PDCCH transmission comprises one of the following:
the PDCCH candidate with the same index as the current PDCCH transmission received by the UE in the latest occasion of the identical search space set, or
the PDCCH candidate with the same index as the current PDCCH transmission received by the UE in an occasion of the identical search space set t′ symbols or slots or milliseconds before the current PDCCH transmission.

In accordance with embodiments, the reference physical channel transmission may be performed with partial or no DMRS muting.

In accordance with embodiments,
a set of physical resource blocks allocated for the current physical channel transmission is a subset of or identical to a set of physical resource blocks allocated for the reference physical channel transmission received/transmitted before the current physical channel transmission, or
a number of symbols allocated for the current physical channel transmission is less than or equal to a number of symbols allocated for the reference physical channel transmission received/transmitted before the current physical channel transmission, or
a set of symbols allocated for the current physical channel transmission within a slot is a subset of or identical to a set of symbols allocated for the reference physical channel transmission within its slot received/transmitted before the current physical channel transmission.

### PTRS Association and Allocation

In accordance with embodiments,
one or more phase-tracking reference signals, PTRSs, are associated with one or some or all DMRSs, and
the UE is to receive a scheduling of the physical channel,
a PTRS associated with a DMRS is activated/deactivated if the corresponding DMRS is activated/deactivated, or
a PTRS associated with a DMRS is activated/deactivated responsive to a first signaling, the first signaling being separate from a second signaling for activating/deactivating the DMRSs.

In accordance with embodiments, the first signaling indicates one or more of the following:
an activation of a PTRS muting,
a PTRS muting pattern of muting for PTRS,
a frequency of PTRS muting.

In accordance with embodiments, PTRS muting comprises a partial or full PTRS muting.

In accordance with embodiments, for partial PTRS muting,
a proper subset of the symbols for which the PTRS is transmitted is muted, or
a parameter regarding a time domain PTRS density is reset from a value according to a PTRS configuration associated with the physical channel to a default value.

### General

In accordance with embodiments, UE is to report to a network entity of the wireless communication system one or more of the following:
a capability to perform DMRS muting,
a capability to apply or activate one or more DMRS muting patterns,
a capability to perform DMRS or DMRS muting dependent on one or more parameters of the physical channel having specific values.

In accordance with embodiments, the physical channel transmission comprises
a downlink, DL, transmission, like a physical downlink shared channel, PDSCH, transmission, or a physical downlink control channel, PDCCH, transmission, or
an uplink, UL, transmission, like a physical uplink shared channel, PUSCH, transmission or a physical uplink control channel, PUCCH, transmission.

In accordance with embodiments, a slot of a subframe of a radio frame comprises one or more transmission occasions of the physical layer.

In accordance with embodiments, a slot of a subframe of a radio frame comprises one or more transmission occasions of a physical channel.

In accordance with embodiments, the UE is to apply DMRS muting in case one or more predefined situations are recognized, e.g., a situation in which
a stable channel condition is assumed to exist over an extended period of time, or
a channel has slowly varying channel conditions between the transmitter and the receiver, or
a periodic channel variation is observed, and
   wherein the UE is to recognize the predefined situation or is to receive a signaling to activate DMRS muting responsive to a network entity of the wireless communication system recognizing the predefined situation.

### Network Entity

The present invention provides a network entity for a wireless communication system, like a 3^{rd} Generation Partnership Project, 3GPP, system, the wireless communication system comprising one or more user devices, UEs,
wherein the network entity is to receive and/or transmit one or more physical channel transmissions from and/or to a UE, and
wherein one or more of the physical channel transmissions are received or transmitted without any associated DeModulation Reference Signal, DMRS, or with a partial or full DMRS muting.

The present invention provides a network entity for a wireless communication system, like a 3^{rd} Generation Partnership Project, 3GPP, system, the wireless communication system comprising one or more user devices, UEs,
wherein the network entity is to schedule one or more physical channel transmissions for one or more of the UEs, and
wherein the network entity is to schedule the physical channel transmission such that one or more of the physical channel transmissions are received at or transmitted by the UE without any associated DeModulation Reference Signal, DMRS, or with a partial or full DMRS muting.

In accordance with embodiments, the network entity is to schedule the physical channel transmission such that
a proper subset of resources or all resources that are associated with a DMRS are muted, thereby implementing partial or full DMRS muting, a muted resource to be occupied by information other than the DMRS or to be left blank, or
a physical channel transmission is not associated with any DMRS thereby implementing full DMRS muting.

In accordance with embodiments, the network entity is to
configure the UE with an absence or a presence of partial or full DMRS during a certain physical channel transmission occasion, and/or
signal the UE an indication of an absence or a presence of partial or full DMRS during a certain physical channel transmission occasion, e.g., via a physical, PHY, layer, like an indication in a downlink control information, DCI, or via a media access control, MAC, layer, like an indication in a MAC control element, MAC-CE, or via a higher layer, like an indication in a radio resource control, RRC, layer.

In accordance with embodiments, the network entity is to
configure the UE with an absence of associated DMRS or a presence of partial or full DMRS muting during a certain physical channel transmission occasion, and/or
signal the UE an indication of an absence of associated DMRS or a presence of partial or full DMRS muting during a certain physical channel transmission occasion, e.g., via a physical, PHY, layer, like an indication in a downlink control information, DCI, or via a media access control, MAC, layer, like an indication in a MAC control element, MAC-CE, or via a higher layer, like an indication in a radio resource control, RRC, layer.

In accordance with embodiments, the network entity is to obtain, for a first transmission occasion of a physical channel with fully or partially muted DMRS, channel information from a second transmission occasion of a physical channel previous to the first one,
wherein the first transmission occasion is a current physical channel transmission, and the second transmission occasion is a reference physical channel transmission, the current and reference physical channel comprising a PUCCH or a PUSCH, and
wherein the network node uses the channel information from the reference physical channel reception for the current physical channel transmission.

In accordance with embodiments, the physical channel comprises a PUSCH, and wherein one or more of the following parameters are identical for the current PUSCH transmission and the reference PUSCH transmission:
one or more transmission configuration indicator, TCI, states,
one or more precoding parameters,
one or more physical resource block bundling parameters,
a modulation and coding scheme, MCS,
DMRS ports,
one or more power control parameters, e.g., p0, a closed loop index, alpha, and the like,
a pathloss reference RS,
a SRS resource indicator.

In accordance with embodiments, the reference PUSCH transmission comprises one of the following:
the latest PUSCH transmission before the current PUSCH transmission,
the latest PUSCH transmission before the current PUSCH transmission with the same HARQ process or transport block ID, or
the PUSCH transmission scheduled by a DCI associated with the same CORESET pool index as the DCI scheduling the current PUSCH.

In accordance with embodiments, the physical channel comprises a PUCCH, and wherein one or more of the following parameters are identical for current PUCCH transmission and the reference PUCCH transmission:
one or more transmission configuration indicator, TCI, states,
one or more precoding parameters,
one or more physical resource block bundling parameters,
one or more power control parameters, e.g., p0, a closed loop index, alpha, and the like,
a pathloss reference RS,
a PUCCH resource group,
a PUCCH resource set.

In accordance with embodiments, the reference PUCCH transmission comprises one of the following:
the latest PUCCH transmission associated with the same PUCCH resource as the current PUCCH transmission,
the latest PUCCH transmission received before the current PUCCH transmission.
the PUCCH transmission scheduled by a DCI associated with the same CORESET pool index as the DCI scheduling the current PUCCH,
the PUCCH transmission associated with the same PUCCH resource group, PUCCH resource set or CORESET pool index as the current PUCCH.

In accordance with embodiments, the reference physical channel transmission may be performed with partial or no DMRS muting.

### System

The present invention provides a wireless communication system, like a 3rd Generation Partnership Project, 3GPP, system, comprising a one or more of the inventive user devices, UEs, and/or one or more of the inventive network entities.

In accordance with embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and entailing input from a gateway node at periodic intervals, or a mobile terminal, or a stationary terminal, or a cellular IoT-UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments, the network entity comprises one or more of a macro cell base station, or a small cell base station, or a central unit of a base station, or a distributed unit of a base station, or an Integrated Access and Backhaul, IAB, node, or a road side unit, RSU, or a UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

### Methods

The present invention provides a method for operating a user device, UE, for a wireless communication system, like a 3^{rd} Generation Partnership Project, 3GPP, system, the method comprising:
receiving and/or transmitting, by the UE, one or more physical channel transmissions,
wherein one or more of the physical channel transmissions are received or transmitted without any associated DeModulation Reference Signal, DMRS, or with a partial or full DMRS muting.

The present invention provides a method for operating a network entity for a wireless communication system, like a 3rd Generation Partnership Project, 3GPP, system, the wireless communication system comprising one or more user devices, UEs, the method comprising:
receiving and/or transmitting, by the network entity, one or more physical channel transmissions from and/or to a UE,
wherein one or more of the physical channel transmissions are received or transmitted without any associated DeModulation Reference Signal, DMRS, or with a partial or full DMRS muting.

The present invention provides a method for operating a network entity for a wireless communication system, like a 3rd Generation Partnership Project, 3GPP, system, the wireless communication system comprising one or more user devices, UEs, the method comprising:
scheduling, by the network entity, one or more physical channel transmissions for one or more of the UEs,
wherein the physical channel transmission is scheduled such that one or more of the physical channel transmissions are received at or transmitted by the UE without any associated DeModulation Reference Signal, DMRS, or with a partial or full DMRS muting.

### Computer Program Product

Embodiments of the first aspect of the present invention provide a computer program product comprising instructions which, when the program is executed by a computer, causes the computer to carry out one or more methods in accordance with the present invention.

Embodiments of the present invention are now described in more detail, and it is noted that the subsequently described aspects and embodiments may be implemented independent from each other or may combined with each other.

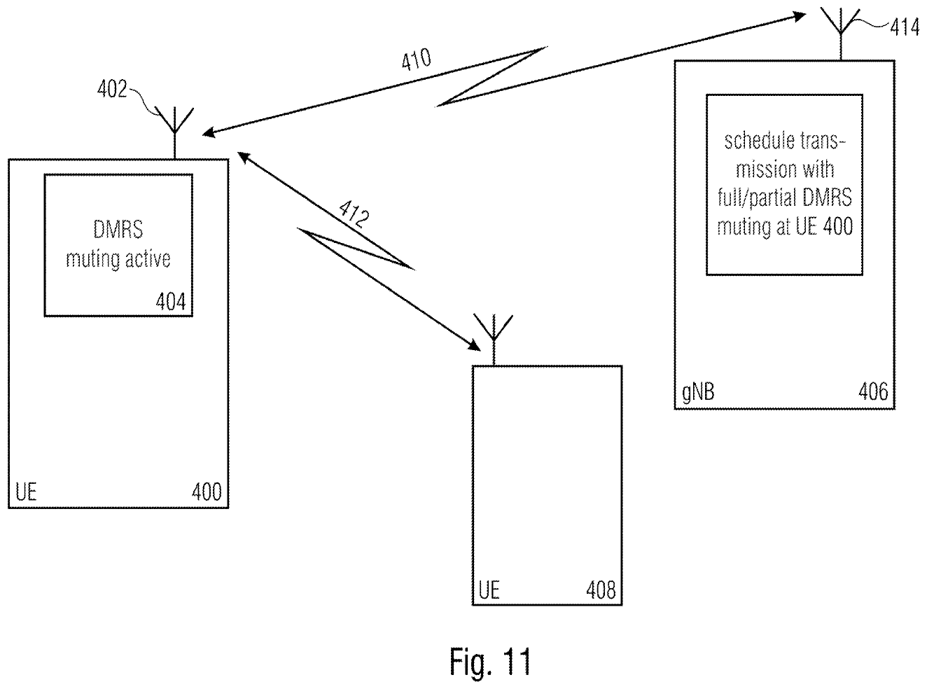

FIG. 11 illustrates a user device, UE, in accordance with embodiments of the present invention. UE 400 comprises one or more antennas 402 and a signal processor 404. UE 400 is to communicate with a base station or gNB 406. UE 400 may also communicate with a further UE 408. UE 400 communicates with the gNB 406 over the Uu interface 410, and with the UE 408 over the PC5 or sidelink interface 412. The signal processor 402 may perform digital signal processing and/or analog signal processing and may include auxiliary support circuits, for example voltage rectifiers and power amplifiers as well as sensors and/or actuators and other analog circuitries. In accordance with embodiments of the present invention, UE 400 receives or transmits transmissions at respective transmission occasions but does not expect a DMRS for every transmission occasion. Stated differently, UE 400 implements the partial of full muting of configured DMRS resources for a physical channel transmission or does not make use of any DMRS configuration for a physical channel transmission. The UE 400 may be a user device for a 3GPP wireless communication system and does not expect a DeModulation Reference Signal, DMRS, for every occasion of a physical channel transmission, e.g., when DMRS muting is activated. In accordance with embodiments, UE 400 is configured or preconfigured with an absence or a presence of partial or full DMRS during a certain physical channel transmission occasion or slot. In accordance with other embodiments, UE 400 receives an indication of an absence or a presence of partial or full DMRS during a certain physical channel transmission occasion or slot, e.g., from a network node 406 of the wireless communication system via a physical, PHY, layer, like an indication in a downlink control information, DCI, or via a media access control, MAC, layer, like an indication in a MAC control element, MAC-CE, or via a higher layer, like an indication in a radio resource control, RRC, layer.

FIG. 11 also illustrates a network entity in accordance with embodiments of the present invention. As is illustrated, the network entity may be a base station 406, like a gNB, that comprises one or more antennas 414 and a signal processor 416. The gNB 400 schedules UE 400 for transmissions at respective transmission occasions such that UE 400 does not expect a DMRS for every transmission occasion. More specifically, the gNB 406 schedules a physical channel transmissions to be received at the UE 400 or to be send by the UE 4000 such that the scheduled UE 400 does not to expect a DeModulation Reference Signal, DMRS, for every occasion of the physical channel transmission. In accordance with embodiments, gNB 406 configures UE 400 with an absence or a presence of partial or full DMRS during a certain physical channel transmission occasion or slot. In accordance with other embodiments, gNB 406 signals UE 400 an indication of an absence or a presence of partial or full DMRS during a certain physical channel transmission occasion or slot, e.g., via a physical, PHY, layer, like an indication in a downlink control information, DCI, or via a media access control, MAC, layer, like an indication in a MAC control element, MAC-CE, or via a higher layer, like an indication in a radio resource control, RRC, layer.

To address the problem that arises from the conventional approach of associating a DMRS with each transmission, embodiments of the present invention provide configuration options to set a lower DMRS density in time. For example, for reducing the DMRS density in time, a dynamic inter-slot or inter-transmission-occasion DMRS configuration is provided. In other words, a DMRS inclusion configuration (the use of DMRS) or a DMRS muting configuration (no use of DMRS) are provided that may change with each slot or transmission occasion of the related channel. For example, the muting of the DMRS may comprise:
Dynamic muting: With each transmission, UE 400 is provided with an indication if the DMRS muting is performed or not in a given slot or for a transmission occasion of a channel.
Semi-persistent muting: A signaling from the network, e.g., from the gNB 406, may indicate to the UE 400 that for a certain number of slots or transmission occasions of a channel, the DMRS is muted, or it may indicate that for a certain number of slots or transmission occasions of a channel a certain pattern of DMRS muting across the slots or transmission occasions is applied.
Semi-static muting: A signaling from the network, e.g., from the gNB 406, may indicate to the UE 400 that DMRS muting is activated at a certain time instant and the DMRS muting is maintained until another signaling is received that deactivates or modifies the DMRS muting.

Thus, in accordance with embodiments, DMRS may be muted for several slots in configurable OFF-durations. Also, it is noted that the inventive approach is applicable to both CP-OFDM and DFT-s-OFDM transmissions, and to the downlink and the uplink directions.

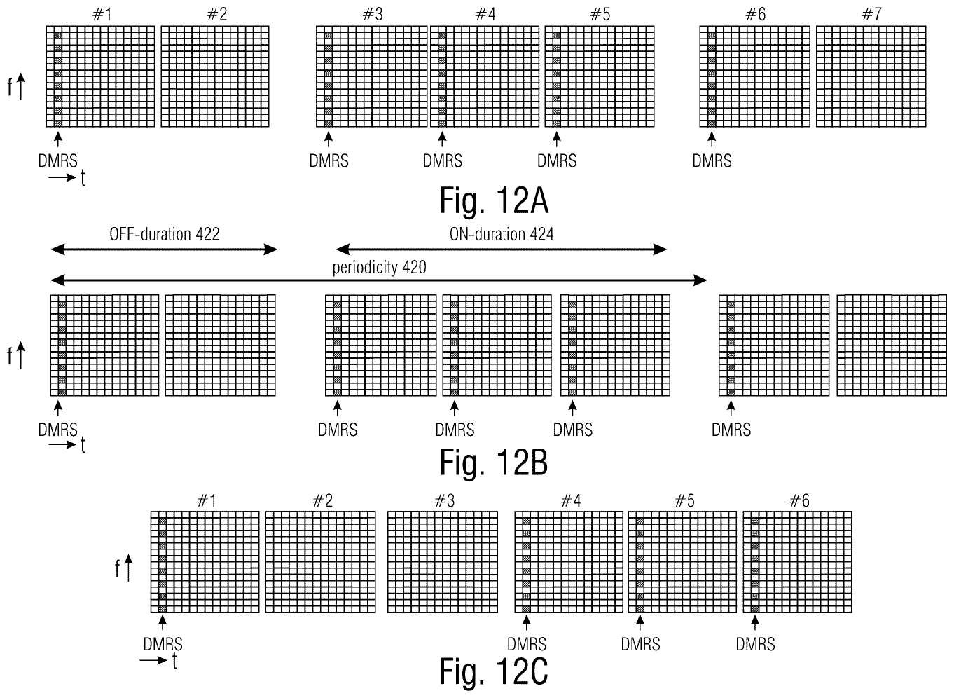

FIGS. 12A-12C illustrates examples for the dynamic, semi-persistent and the semi-static DMRS muting in accordance with embodiments of the present invention. FIG. 12A illustrates an example for the dynamic DMRS muting in accordance with embodiments of the present invention. FIG. 12A shows seven slots #1 to #7 of a physical resource grid used for the transmission, each slot including 14 OFDM symbols and 16 subcarriers. Assuming a transmission, received at or transmitted by UE 400, to span the slots #1 to #7, UE 400 receives an indication, like a DCI, which, in addition to scheduling the resources for the transmission, also indicates that DMRS is applied (DMRS muting is not performed-see the symbols labeled DMRS including REs associated with a DMRS) in slots #1 and #3 to #6, while DMRS muting is performed in slots #2 and #7. Also, when considering that in each slot one seven transmission is performed, the respective DCIs may indicate for the transmission whether DMRS muting is active or inactive.

FIG. 12B illustrates an example for the semi-persistent DMRS muting in accordance with embodiments of the present invention. FIG. 12B shows seven slots #1 to #7 of a physical resource grid used for the transmission, each slot including 14 OFDM symbols and 16 subcarriers. Assuming a transmission, received at or transmitted by UE 400, to span the slots #1 to #7, UE 400 receives an indication, like a DCI, which, in addition to scheduling the resources for the transmission, also indicates that DMRS is muted in the slot following slot #1 and slot #6, otherwise DMRS is applied (DMRS muting is not performed-see the symbols labeled DMRS including REs associated with a DMRS) in slots #1 and #3 to #6. In accordance with other embodiments, UE 400 may receive an indication of a DMRS muting pattern that is repeated with a certain periodicity 420 and that includes one or more OFF-durations 422 and one or more ON-durations 424. For example, the OFF duration may have a duration of two slots, like slot #1 and slot #2, and indicate that in the slot (slot #2) following an initial slot (slot #1) DMRS muting is performed. During the OFF duration (slots #3 top #5) DMRS is applied (DMRS muting is not performed-see the symbols labeled DMRS including REs associated with a DMRS). The patters the repeats starting with slot #6.

FIG. 12C illustrates an example for the semi-static DMRS muting in accordance with embodiments of the present invention. FIG. 12C shows seven slots #1 to #6 of a physical resource grid used for the transmission, each slot including 14 OFDM symbols and 16 subcarriers. Assuming a transmission, received at or transmitted by UE 400, to span the slots #1 to #6, UE 400 receives an indication, like a DCI, which, in addition to scheduling the resources for the transmission, also indicates that DMRS is muted in the slots following slot #1. For slot #4 UE 400 receives a further signaling, like a further DCI, signaling that DMRS muting is disabled so that in slots #4 to #6 DMRS is applied (DMRS muting is not performed-see the symbols labeled DMRS including REs associated with a DMRS). In other words, gNB 406 may indicate to UE 400 that DMRS muting is activated at a certain time instant (after slot #1) and the DMRS muting is maintained until another signaling is received that deactivates the DMRS muting (at slot #4).

Although it has been described with reference to FIGS. 12A-12C that a transmission may span one or more slots, it is noted that a transmission may also be shorter so that a slot (like any one of slots #1 to #7 in FIGS. 12A-12C) of a subframe of a radio frame may include one or more transmissions or transmission occasions of a physical layer transmission.

Thus, in accordance with embodiments, UE 400 receives a PDxCH transmission without any associated DMRS or with full/partial muting of DMRS, or performs a PUxCH transmission without any associated DMRS or with full/partial muting of DMRS. That is, a network node, receives a PUxCH transmission without any associated DMRS or with full/partial muting of DMRS, or performs a PDxCH transmission without any associated DMRS or with full/partial muting of DMRS. The indication of the absence or the full/partial muting of the DMRS during a certain PDxCH or PUxCH transmission occasion may be provided to UE 400 by a network node 406 via the PHY-layer (e.g., an indication in a DCI), via the MAC-layer (e.g., a MAC-CE) and/or via a higher layer (e.g., RRC), or it may be known beforehand (preconfigured) at the UE (e.g., a DMRS activation/deactivation pattern may be fixed in the specification, optionally in combination with via a PHY-layer and/or higher layer indication).

It is to be noted that ‘a physical channel transmission occasion’ and ‘a physical channel transmission’ may be used interchangeably in the invention disclosure. The ‘physical channel’ in said phrases may, in some cases, be any specific physical channel in a wireless communication system such as a physical downlink shared channel, a physical downlink control channel, a physical uplink shared channel or a physical uplink control channel.

In accordance with embodiments of the present invention, the muting of DMRS resource elements during a transmission occasion of a physical channel may be realized in different ways and multiple types of muting are possible. In accordance with embodiments, the UE is configured to receive a PDxCH transmission or to perform a PUxCH transmission, and
a proper subset or all of the resource elements that are associated with a DMRS configuration for said transmission occasion of the channel (PxxCH or PDxCH/PUxCH) are occupied by the channel or by another channel or by a signal or are left blank/unoccupied, e.g., are transmitted with zero power, or
the channel (PxxCH or PDxCH/PUxCH) transmission is not provided with an associated DMRS configuration.

It is noted that in the description of the embodiments of the present invention, the following terms are used:
The term proper subset is used in its mathematical sense, i.e., a proper subset of a set A is a subset of A that is not equal to A. In other words, if B is a proper subset of A, then all elements of B are in A but A contains at least one element that is not in B.
The term signal may refer to any reference signal in the UL or DL other than a DMRS. If the transmission in discussion is in the DL, then the use of the term signal refers to a DL reference signal other than a DMRS and if the transmission is in the UL, then signal refers to a UL reference signal other than a DMRS.
The term resource elements associated with a DMRS/PTRS configuration or resource elements according to a DMRS/PTRS configuration for a channel or a transmission occasion of a channel (PTRSs=phase-tracking reference signals associated with some DMRS ports) may denote the resource elements in one or more layers of the channel or the transmission occasion of the channel that are allocated for the DMRS associated with the channel according to at least one of the following:
   any higher layer configuration associated with DMRS/PTRS for the channel, e.g., a RRC configuration of DMRS/PTRS for the channel,
   a MAC Control Element, MAC-CE, or DCI signaling associated with at least one of the following parameters regarding said DMRS/PTRS:
      an indication of single/double-symbol DMRS allocation, i.e., the number of front-load symbols for DMRS,
      an indication of the DMRS ports,
      an indication of a PTRS-DMRS ports association.
The term UL (PUxCH) or DL (PDxCH) transmission without an/any associated DMRS/PTRS may imply that there is no DMRS/PTRS (configuration and/or port(s)) associated with the UL or DL transmission.
The term UL (PUxCH) or DL (PDxCH) transmission with fully muted DMRS/PTRS or UL (PUxCH) or DL (PDxCH) transmission with full muting of DMRS/PTRS may imply at least one or more of the following:
   The UL or DL transmission is associated with a DMRS/PTRS configuration and, thereby, one or more DMRS/PTRS ports, and all the resource elements associated with the DMRS/PTRS configuration may be used for the transmission of a PxxCH or a signal other than the DMRS/PTRS.
   This means that a transmission of a channel (PxxCH or PDxCH/PUxCH) may be performed, and there is a correspondence between the one or more layers of the channel that are transmitted and one or more DMRS/PTRS ports or port numbers associated with the channel, however, all the resource elements that are typically reserved for DMRS/PTRS in each port or layer of the transmission may be occupied by the payload of the corresponding channel or a payload of a different channel or any reference signal other than the DMRS/PTRS.
   The UL or DL transmission is associated with a DMRS/PTRS configuration and, thereby, one or more DMRS/PTRS ports, and all the resource elements associated with the DMRS/PTRS configuration may be left blank, e.g., the resource elements have zero power.
   There is no DMRS/PTRS (configuration and/or port(s) associated with the UL or DL transmission.
The term UL (PUxCH) or DL (PDxCH) transmission with partial DMRS/PTRS muting or UL (PUxCH) or DL (PDxCH) transmission with partial muting of DMRS/PTRS may mean the following:
   The UL or DL transmission is associated with a DMRS/PTRS configuration and, thereby, one or more DMRS/PTRS port(s), and a proper subset of the resource elements associated with the DMRS/PTRS configuration may be used for the transmission of a PxxCH or a signal other than the DMRS/PTRS or may be left blank, e.g., the resource elements have zero power.
The term UL (PUxCH) or DL (PDxCH) transmission with an associated DMRS/PTRS may typically mean that there is no full/partial DMRS/PTRS muting as described in accordance with embodiments of the present invention.
This means that, for example, the above described conventional DMRS approach may be applied.
If a resource element is associated with a DMRS/PTRS configuration but used for the transmission of a channel or a signal other than DMRS/PTRS or is left blank, it may be called a muted resource element. A muted resource element may, in general, be associated with a time-domain symbol or slot index, e.g. l, and a frequency-domain subcarrier or physical resource block index, e.g. k. When the indication of a muting is applied to a UL or a DL transmission which is associated with a partial/full muting, the muting indication may be associated with a muting pattern, and the muted resource element(s) of the partial/full muting may be identified by association of one or more time-domain symbol or slot indices and/or one or more frequency-domain subcarrier or physical resource block indices. In other words, a muted resource comprise one or more of the following: a part of a payload of the associated physical channel transmission, a part of a payload of a different physical channel transmission, any physical signal other than the DMRS.
The term data of a transmission is referred to as control data and payload data so the term payload refers to data not including any control data associated with the transmission.

Thus, for a given muting technique (full or partial), multiple ways of realizing it may exist, as mentioned above. Each one of them has different specification consequences, control information overhead and apply to different use-cases. A full muting of the DMRS for a given PxxCH may be performed by configuring the DMRS for the channel via a higher layer and then dynamically muting it during different transmission occasions of the channel or by completely eliminating the DMRS configuration for the channel itself. In the first method, the control overhead due to the RRC configuration for the DMRS is entailed, while it is not required for the second method. In both the methods, the indication or the specification of how the channel state information, CSI, for the demodulation of the channel is obtained is additionally entailed. The corresponding explanation and techniques for CSI evaluation for demodulation are provided later. The first method may allow for any frequency of muting (fully dynamic, semi-persistent or semi-static) and hence may support, e.g., any type of UE mobility variation. The second method is useful in cases of low mobility communications or when there is very little change in a relative velocity between the UE and the network node. In such scenarios, only a semi-static muting configuration may be enabled. In the case of partial muting of a given channel, a DMRS configuration is needed and it may not be eliminated as in the case of full muting. Further, as in the case of full muting with a DMRS configuration, any frequency of muting may be supported for partial muting.

### With Regard to the Approaches Described Herein, the Following is Noted:

1. Several approaches or methods in this disclosure are written from a UE's perspective. For example, the UE may be involved in a reception of
   a configuration/indication of a value or a setting for a parameter or property of a particular channel and/or RS, or
   a channel and/or RS.
   When not mentioned explicitly, it is implied that the transmitter of said configuration/indication or channel/RS is a network node. Any ‘transmission’ of a channel or RS or any information by a UE, implies that said transmission is received by the same network node, a network entity different from said network node or another UE.
2. In some embodiments, an approach or method that may be applicable for both UL and DL channel(s) and/or RS(s) may be provided without an association with a transmitting or receiving entity. It is implied in such cases that any associated UL transmission of a channel or RS is performed by a UE wherein a network node is the receiver. The UE may apply parts of the method that are applicable for the transmission of said channel/RS and the network node may apply the parts of the method that are applicable for the reception of said channel/RS. Similarly, it is implied that any associated DL transmission of a channel or RS is performed by a network node wherein a UE is the receiver. In this case, the UE may apply parts of the method that are applicable for the reception of said channel/RS and the network node may apply the parts of the method that are applicable for the transmission of said channel/RS.

### Indication of DMRS Muting

The muting of the DMRS may be enabled by signaling the indication via lower layers, such as medium access control, MAC, layer and/or the physical, PHY, layer, or a higher layer, such as the RRC, or a combination of one or more layers. For example, the using downlink control information, DCI, message or a MAC-Control Element, MAC-CE, message enables a faster changing of a muting configuration or pattern to adapt to changes in the channel. It is also possible to use a combination of more than one layer (PHY-layer and/or one or more higher layers) for this purpose.

In accordance with embodiments, UE 400 may receive a PHY-layer and/or higher layer signaling (such as a MAC-CE or RRC signaling) that indicates an activation or deactivation of DMRS muting for one or more PDxCHs or for one or more PUxCHs in one or more slots or transmission occasions.

It is noted that in the description of the embodiments of the present invention, the following terms are used:
The term activate DMRS/PTRS transmission for an uplink (PUxCH) or downlink (PDxCH) transmission may mean that the uplink or downlink transmission is performed in association with a DMRS/PTRS and there is no muting performed.
The term deactivate DMRS/PTRS transmission for an uplink or downlink transmission may mean that the uplink or downlink transmission is performed with full or partial muting of the associated DMRS/PTRS.
The term activate a DMRS/PTRS muting for an uplink (PUxCH) or downlink (PDxCH) transmission may mean that the uplink or downlink transmission is performed with full or partial muting of the associated DMRS/PTRS.
The term deactivate a DMRS/PTRS muting for an uplink (PUxCH) or downlink (PDxCH) transmission may mean that the uplink or downlink transmission is performed in association with a DMRS/PTRS and there is no muting performed.
The term deactivate/deactivating/deactivation (of) DMRS/PTRS may be interchangeably used with mute/muting (of) DMRS/PTRS, which indicates either a full/partial muting of the associated DMRS/PTRS.

### DCI-Based Muting

In accordance with embodiments, UE 400 may receive a DCI that indicates an activation or deactivation of DMRS muting for one or more PDxCHs or for one or more PUxCHs in one or more slots. UE 400, in addition, may be indicated via a higher layer (e.g., RRC) if UE 400 may receive a DCI with such an indication. The UE's reception of the DCI may be conditioned on the reception of the aforementioned higher layer indication and/or a UE's reporting of a capability to receive and/or process a DCI with such an indication.

The one or more DCIs providing the indication may be the ones scheduling the PDxCH(s) or PUxCH(s), or they may be the ones separate from the DCI(s) scheduling said PDxCH(s) or PUxCH(s). When a separate DCI performs the task, the indication may be performed for a specific channel or a subset of transmissions associated with a specific channel, which may be considered a way of performing semi-static DMRS muting. When the scheduling DCI indicates the muting, the indication may be fully dynamic.

In accordance with embodiments, the UE 400 receives an indication of the activation or deactivation of a DMRS muting for one or more PDSCHs or PUxCHs on a DCI in one or more slots or transmission occasions, and the DCI may also schedule or indicate the transmission of the one or more channels. Fully dynamic muting or semi-persistent muting is possible with such an indication. When the DCI scheduling the channel is providing the muting indication, the indication may be used just for the one or more scheduled transmission occasions of the channel or it may be used for one or more subsequent transmission occasions as well.

In accordance with embodiments, UE 400 receives an indication of the activation or deactivation of a DMRS muting for one or more PDxCHs or for one or more PUxCHs in one or more slots or transmission occasions on a DCI, and the DCI does not schedule or indicate the one or more PDxCHs or PUxCHs. In some examples, the DCI may not comprise any data assignment, i.e., does not schedule a UL/DL shared channel transmission(s). In this embodiment, a semi-persistent muting is highly likely as the DCI is not tied to any specific data assignment.

In an example, the field in the DCI which provides the indication may be the Antenna Ports field in a conventional DCI format 1_1 or in a conventional DCI format 0_1, the DCI formats used to schedule a PDSCH or a PUSCH. Certain codepoints of the field are reserved, i.e., they are not mapped to any DMRS port. If the Antenna Ports field in the DCI comprises a codepoint that is reserved, then it may serve as an indication of DMRS muting for the one or more PDxCHs or the one or more PUxCHs in one or more slots or transmission occasions. Reusing of existing fields is helpful in reducing a DCI overhead and increasing its reliability.

It is to be noted that a field in a DCI is an allocation of a set of bits to indicate a specific setting. A codepoint of a field may denote one of the possible patterns of bits in the field or a non-binary value that said pattern of bits maps to (for example, the decimal representation of the pattern of bits).

In another example, the field in the DCI which provides the indication may be a dedicated field to indicate a DMRS muting. For instance, the DCI field may indicate a value of f₀, which may mean that a DMRS muting applies or is activated for one or more PDxCHs or PUxCHs in one or more slots or transmission occasions after the DCI, and if the DCI field indicates a value of f₁, it means that the DMRS muting is deactivated for the one or more transmissions. The DCI, in this case, may be of a format that schedules DL or UL transmissions. In this case, having a dedicated field helps in decoupling from other DMRS signaling in the DCI, thereby reducing specification and implementation effort. Moreover, when a DCI indicates the DMRS muting, it may apply to various sets of channels associated with the DCI.

In accordance with embodiments, the UE receives an indication of the activation or deactivation of a DMRS muting on a DCI that schedules one or more PDSCHs or PUSCHs in one or more slots or transmission occasions, and the indication of the DMRS muting may apply to at least one of the following:
The PDSCHs or PUSCHs scheduled by the DCI.
All the PDSCH or PUSCH transmission occasions associated with a Hybrid Automatic Repeat Request, HARQ, identifier or HARQ process number indicated in the DCI.
All the PDSCH or PUSCH transmission occasions associated with an identical value for at least one of the following allocation parameters: number of symbols, number of subcarriers or resource blocks, number of layers.
One or more PUCCH resources that carry the acknowledgement or negative acknowledgement, HARQ-ACK/NACK, for the one or more PDSCHs scheduled by the DCI.
One or more PUCCH resources that are indicated in the PUCCH resource indicator field of the DCI.
The CORESET associated with the DCI (thereby the one or more PDCCHs associated with the CORESET).
The one or more CORESETs associated with the same CORESET pool index value as the CORESET associated with the DCI (and thereby the one or more PDCCHs associated with the one or more CORESETs).
All the CORESETs in one or more active bandwidth parts in UL and/or in DL.

A higher layer signaling or one or more fixed specification directives may be used to select a proper subset or all of the above sets of channels for the application of the muting indication.

If the muting applies just to the scheduled PUSCH or PDSCH and/or the associated PUCCH and/or PDCCH, then the muting is dynamically enabled/disabled per slot or per transmission occasion or per transport block.

In accordance with embodiments, for implementing semi-persistent muting, the muting indication across multiple channels and/or transmission occasions may be applied as follows. In accordance with embodiments, UE 400 receives an indication of the activation or deactivation of a DMRS muting on a DCI, and the indication of the DMRS muting may apply to at least one of the following:
One or more PDSCHs and/or PUSCHs up to n≥1 slots or transmission occasions after the DCI, and the value of n is higher-layer-configured or fixed in the specifications.
One or more PDxCHs and/or PUxCHs up to n≥1 slots or transmission occasions after the DCI, and the value of n is higher-layer-configured or fixed in the specifications.
One or more PDSCHs and/or PUSCHs up to n≥1 slots or transmission occasions after the DCI, and associated PUCCH(s) and/or PDCCH(s), and the value of n is higher-layer-configured or fixed in the specifications.

The associated PUCCH(s) may be one of the following:
the PUCCH resource(s) that carry the acknowledgement or negative acknowledgement, HARQ-ACK/NACK, for said PDSCH(s),
the PUCCH resource(s) indicated by said DCI,
the PUCCH resource(s) associated with a preconfigured or indicated value of an index such as a CORESET pool index or a PUCCH resource group index, or
all or a subset of UE dedicated PUCCH resource(s) in a CC.

Similarly, the associated PDCCHs may be one of the following:
all PDCCH(s) (and hence, the associated CORESET(s)) in the active DL BWP of a CC,
all PDCCH(s) associated with either UE-specific search space sets or common search space sets in the active DL BWP of a CC,
the PDCCH(s) scheduling said PDSCH(s) or PUSCH(s),
one or more PDCCHs associated with a CORESET on which the DCI indicating the DMRS muting activation or deactivation is transmitted,
one or more PDCCHs associated with one or more CORESETs configured with the same CORESET pool index value as the CORESET on which the DCI indicating the DMRS muting activation or deactivation is transmitted,
one or more PDCCHs associated with a CORESET on which the DCI scheduling the PDSCH(s) or PUSCH(s) is transmitted, or
one or more PDCCHs associated with one or more CORESETs configured with the same CORESET pool index value as the CORESET on which the DCI scheduling the PDSCH(s) or PUSCH(s) is transmitted.

In accordance with embodiments, applying the muting indication to the PDSCHs and associated PUCCHs is a use-case for multi-TRP transmissions with separate HARQ settings, as each downlink transmission is associated with a HARQ transmission to a respective TRP. When both a DL and UL resource are associated with a specific TRP, to synchronize the DMRS muting setting for both, a single indication of DMRS muting may be applied for both together.

A similar case may be used for the joint application of the DMRS muting for just the one or more downlink channels PDSCH and PDCCH when the channels or a subset of the channel's transmissions are associated with a single TRP.

The sets of channels to which a DCI indication of DMRS muting applies may be configured via a higher layer or may be fixed in the specifications (and, therefore preconfigured at the UE). In addition, the DMRS muting may be applied to a repetition of a PDSCH or a PUSCH as follows. In accordance with embodiments, the indication of the activation of a DMRS muting for a PDSCH or PUSCH with repetition via a DCI may apply only to the repetitions of the PDxCH or the PUxCH transport block and/or any other channel associated with it such as the one or more PUCCHs carrying the HARQ-ACK/NACK for the PDSCH, the one or more PUCCHs indicated in the PUCCH resource indicator in the DCI, or the one or more PDCCHs associated with the one or more CORESETs that are associated with the DCI. The application of DMRS muting to transmission repetitions is discussed in greater detail further below.

### MAC-CE-Based Muting

In accordance with embodiments, UE 400 may receive a MAC-CE message that activates or deactivates the DMRS transmission for one or more PUxCH or PDxCH transmission occasions in one or more slots. Similar to the DCI-based indication described above, UE 400, in addition, may be indicated via a higher layer (e.g., RRC) if the UE may receive a MAC-CE message with such an indication. The UE's reception of the MAC-CE message may be conditioned on the reception of the aforementioned higher layer indication or a UE's reporting of a capability to receive and/process the MAC-CE.

When the muting indication is received via a MAC-CE indication, it may apply to various sets of channels. In accordance with embodiments, UE 400 receives an indication of the activation or deactivation of a DMRS muting on a MAC-CE message, and the indication of the DMRS muting may apply to at least one of the following:
One or more PDSCHs and/or PUSCHs up to n≥1 slots or transmission occasions after the reception of the MAC-CE message, and the value of n is higher-layer-configured or fixed in the specifications.
One or more PDxCHs and/or PUxCHs up to n≥1 slots or transmission occasions after the reception of the MAC-CE message, and the value of n is higher-layer-configured or fixed in the specifications.
One or more PDSCHs and/or PUSCHs up to n≥1 slots or transmission occasions after the reception of the MAC-CE message, and the associated PUCCH(s) and/or PDCCH(s) and the value of n is higher-layer-configured or fixed in the specifications.

The associated PUCCH(s) may be one of the following:
the PUCCH resource(s) that carry the acknowledgement or negative acknowledgement, HARQ-ACK/NACK, for said PDSCH(s), the PUCCH resource(s) associated with a preconfigured or indicated value of an index such as a CORESET pool index or a PUCCH resource group index, or all or a subset of UE dedicated PUCCH resource(s) in a CC.

Similarly, the associated PDCCHs may be one of the following:
all PDCCH(s) (and hence, the associated CORESET(s)) in the active DL BWP of a CC,
all PDCCH(s) associated with either UE-specific search space sets or common search space sets in the active DL BWP of a CC,
the PDCCH(s) scheduling said PDSCH(s) or PUSCH(s), one or more PDCCHs associated with a CORESET on which the DCI scheduling the PDSCH(s) or PUSCH(s) is transmitted, or
one or more PDCCHs associated with one or more CORESETs configured with the same CORESET pool index value as the CORESET on which the DCI scheduling the PDSCH(s) or PUSCH(s) is transmitted.

In accordance with embodiments, there may be an indication to which set of channels the indication may apply to via a field in the MAC-CE message itself or via higher layer signaling, or the MAC-CE's applicability to one or more channels may be fixed in the specifications.

### Muting Via RRC or a Combination of Layers

When the muting or a muting pattern is enabled only via RRC, it results in a semi-static muting. The muting settings may be modified or the muting itself may be deactivated only via RRC reconfiguration which has a higher latency than an activation or a deactivation or a modification via lower layers. This may be helpful when the channel is relatively or completely static and leads to a reduced overhead on the lower layers.

In accordance with embodiments, UE 400 receives an RRC parameter that indicates a DMRS muting activation for one or more UL (PUxCH) or DL (PUxCH) channels or transmissions. Upon reception of the muting activation, the UE transmits the one or more UL channels or receives the one or more DL channels with full or partial muting (which may depend on other settings) in one or more slots or transmission occasions.

In an example that uses a fixed specification directive for the UE regarding DMRS activation/deactivation (the UE is preconfigured accordingly), the UE may be provided with a PHY-layer or higher layer indication that serves like an ON/OFF button, which when set to ON indicates that a pattern of DMRS muting is applied (optionally along with a muting pattern) and when set to OFF indicates that the application of the DMRS muting pattern is stopped.

In any of the above-mentioned indications, the indication or an activation of DMRS muting received from a network node via the PHY-layer and/or higher layer may be associated with one or more DMRS muting settings and/or patterns. The muting settings or patterns may be indicated to the UE by the network via PHY layer and/or higher layer or may be fixed in the specifications (known to/preconfigured in the UE).

Muting with Repeated Transmissions

When a repetition of a PDxCH or PUxCH is configured, the DMRS muting may apply for a given set of repetitions associated with the same transport block.

In accordance with embodiments, UE 400 receive a scheduling of a PDxCH with repetition or a PUxCH with repetition, at least one of the PDxCH or PUxCH repetitions is performed with DMRS muting, and the indication of the muting is provided via the PHY-layer and/or a higher layer.

In an example of a PDxCH or PUxCH repetition with DMRS muting, only the first instance of the transmission is performed without DMRS muting (like slot #1 in FIG. 12C) while the other instances of the transmission are performed with DMRS muting (like slots #2 and #3 in FIG. 12C). This may enable all the instances of transmission starting from the second one to obtain the CSI for demodulation from the first one. The indication of the application of such a DMRS muting pattern may be indicated explicitly via a network node and/or may be preconfigured/fixed in the specifications.

In another example, a configuration and/or indication or a muting pattern associated with the repetitions may be performed via the PHY-layer and/or a higher layer.

### Muting Patterns

In accordance with embodiments, any activation or deactivation signaling may be associated with a muting pattern and the application of the DMRS muting may involve the application of the muting pattern, e.g., in the time-domain, to one or more PDxCH or PUxCH transmission occasions or slots and/or, e.g., in the frequency-domain, to a set of subcarriers associated with muted resource elements.

DMRS muting patters may be indicated explicitly or implicitly, with appropriate settings used for the respective configuration. A DMRS muting pattern may, in general, be categorized as a time-domain pattern and/or a frequency-domain patterns. A time-domain pattern may be considered as a series of DMRS activations and/or deactivations applied to at least two or more PUxCH or PDxCH transmission occasions or slots. The PUxCH or PDxCH slots or transmission occasions to which a given muting pattern is applied may be consecutive. A time-domain pattern may be associated with a frequency-domain pattern. A frequency domain pattern may perform a partial muting of DMRS REs across the frequency domain. It may be considered as a series of activations or deactivations of DMRS REs across the frequency domain. For example, a set of subcarrier indices associated with resource elements (per physical resource block) configured for a DMRS transmission along with one or more PDxCHs or PUxCHs may be provided to the UE, and the provided subcarrier indices are to be muted. In certain examples or partial muting, a frequency domain muting pattern may be applied across a series of PDxCH or PUxCH transmission occasions or slots according to a time-domain muting pattern-if a certain PDxCH or PUxCH transmission occasion or slot is to be applied with DMRS muting, a frequency domain DMRS muting pattern may be applied to it. For full muting, indicating DMRS muting only in the time-domain (for individual transmission occasions or slots, or a series of transmission occasions or associated channels) suffices and a frequency domain pattern is not required.

In accordance with embodiments, the indication or an activation of DMRS muting received from a network node via the PHY-layer and/or higher layer may be associated with a DMRS muting pattern. The application of a muting pattern may imply the application of a series of DMRS muting activations and/or deactivations across two or more PUxCH or PDxCH transmission occasions or slots. The muting pattern may be provided to the UE in multiple ways as follows.
Indication from the network via the PHY layer:

The indication of a pattern may be provided via a DCI. A field in the DCI indicates a specific DMRS muting pattern to be applied or activated and/or deactivated-a codepoint with value f₀ may denote a certain pattern A and a codepoint with value f₁ may denote a certain pattern B′ and a certain optional codepoint fᵢ may indicate no pattern or may indicate the deactivation of a DMRS muting or the deactivation of a previously applied DMRS muting pattern.
Indication from the network via PHY-layer and/or one or more higher layers:

The indication of the DMRS muting pattern is performed by a combination of layers. In an example, a list of patterns may be configured via a higher layer (e.g., RRC). From the list provided, either a MAC-CE or a PHY-layer signaling may provide a down-selection of one or more patterns, of which one may be further selected for application or activation via a further PHY-layer or MAC-CE signaling. In another example, from the list of higher layer (e.g., RRC) configured muting patterns, one may be chosen for application or activation from the configured patterns via PHY-layer of MAC-CE signaling.
Indication from the network via a higher layer:

A specific pattern for application or activation is configured via a higher layer (e.g., RRC, MAC-CE). For example, a field in the DMRS configuration of a channel may provide a muting pattern for application. In another example, a muting pattern may be indicated in a MAC-CE message, which may optionally serve as an activation for muting as well. The deactivation of the muting may also be performed by a MAC-CE message (which may be of the same/similar format or of a different format as the activation MAC-CE).
Fixed muting pattern(s) in the specifications (known to/preconfigured in the UE), with optional signaling from the network:

The specifications may provide one or more DMRS muting patterns. The activation or application of a DMRS muting pattern provided in the specifications may be performed via an activation signaling from a network node. The activation signaling may contain a selection from the muting patterns listed in the specifications; or an index that maps to one of the patterns in the list may be provided by the network via the PHY-layer or a higher layer, thereby activating a muting pattern to be applied for one or more PUxCHs or PDxCHs; or the activation signaling may just be a ON/OFF signaling from a PHY-layer and/or a higher layer for an applicable DMRS muting pattern provided in the specifications. In some examples, the activation or application of a DMRS muting pattern provided in the specifications may be performed by the UE depending on at least one of the following conditions:
an activation signaling from a network node,
one or more transmission parameters of the associated one or more PDxCHs or PUxCHs (e.g., PDxCH/PUxCH mapping type, DMRS configuration, etc.-a specific pattern may be applicable only if certain parameters have specific values that fit a DMRS muting pattern) assigned with preconfigured or fixed values.
a UE capability to apply/activate an applicable or given DMRS muting pattern to one or more PDxCHs or PUxCHs.

In accordance with embodiments, after receiving an activation of a DMRS muting that is associated with a muting pattern, the muting pattern may be applied up to a predetermined (fixed in the specifications) or an indicated (provided by the network) number of slots or transmission occasions for the one or more PUxCHs and/or PDxCHs. Following that, the muting pattern may be
repeated after completing the pattern cycle until a deactivation signaling for the muting is received,
repeated until a timer is expired, wherein the said timer is started after activation of DMRS muting pattern, or
stopped after one full cycle of application for the number of slots or transmission occasions.

The first method corresponds to a semi-persistent pattern application while the second method corresponds to a dynamic or on-demand one-shot pattern application. The deactivation signaling may be obtained from the same signaling medium as the one providing the activation signaling (which is applicable in a semi-persistent pattern application scenario).

In accordance with embodiments, the UE may be configured to report to a network node, at least one of the following:
The capability to perform DMRS muting.
The capability to apply or activate one or more given/predetermined DMRS muting patterns.
The capability to perform DMRS muting given one or more parameters of the PUxCH or the PDxCH or the DMRS.

In accordance with embodiments, to configure a muting pattern, several parameters may have to be defined and according to the muting pattern to be defined, the parameters may differ. In accordance with embodiments, a muting indication or a muting pattern indication may be provided to the UE via one or more of the following parameters:
The frequency or periodicity of muting:
This may indicate how often a muting pattern or a muting occasion is applied to one or more PUxCHs or PDxCHs and it may be expressed in terms of a number of slots or transmission occasions or symbols or in terms of milliseconds.
For example, a value s for the periodicity of the DMRS muting may indicate that for every s PDxCH or PUxCH occasions, DMRS muting or the DMRS muting pattern is activated, or for every s PDxCH or PUxCH occasions, DMRS muting or DMRS muting pattern is deactivated.
The offset value:
An offset for the activation or application of a muting pattern, which may be expressed in terms of a number of slots or transmission occasions or symbols or in terms of milliseconds.
A starting slot or subframe or frame number for the application of the muting
A bitmap indicating a muting pattern for a certain number of slots or transmission occasions:
A bitmap of length N≥1 may be applied to N transmission occasions or slots, and for an occasion i∈{1, 2, . . . , N}, if the value of the bitmap at the i-th position is 1, DMRS is muted for the transmission occasion or slot, and if the value is 0 the DMRS is not muted for the transmission occasion or vice versa.
A duration of a muting pattern

In accordance with embodiments, a muting indication or a muting pattern indication for muting of DMRS REs across the frequency domain may be provided to the UE via at least one of the following parameters:
A bitmap indicating a muting pattern per resource block, wherein the bitmap is of length N_{sc}^{RB}. The variable N_{sc}^{RB} denotes the number of subcarriers in a resource block. For a subcarrier index k∈{1, 2, . . . , N_{sc}^{RB}}, if the value of the bitmap at the k-th position is 1, the associated DMRS resource element is muted, and if the value is 0, instead, the associated DMRS resource element is not muted or vice versa.
A bitmap indicating a muting pattern per resource block, and the bitmap is of length N_{sc,DM RS}^{RB}. The variable N_{sc,DM RS}^{RB} denotes the number of subcarriers corresponding to DMRS within a physical resource block according to higher layer configuration. For a DMRS resource elements index p∈{1, 2, . . . , N_{sc,DMRS}^{RB}} within a resource block, if the value of the bitmap at the p-th position is 1, the p-th DMRS resource element in a PRB is muted, and if the value at the p-th position is 0, the p-th DMRS resource element in a PRB is not muted or vice versa. It is to be noted that the value of N_{sc,DM RS}^{RB} is equal to 6 for DMRS configuration type 1 and 4 for DMRS configuration type 2 in 3GPP 5G NR (see references [1] to [4]).
An offset value:
An offset value K_{DMRS}^{Muting} for the indication of the muting pattern may indicate the starting subcarrier number, from which DMRS resource elements are muted, i.e., the subcarrier number from which muted resource elements start. For example, a value of k_{DMRS}^{Muting}=5 may indicate that all DMRS resource elements that have subcarrier index greater than or equal to 5 in every resource block are muted.

With the above description regarding the muting pattern indications and the parameters used to define them, specific methods of muting pattern indications are now provided. In accordance with embodiments, a single bit bₘ may be used to indicate the muting pattern via a DCI or a MAC-CE message, and the presence or absence of the field in the DCI or the MAC-CE message that carries bₘ may implicitly indicate the activation or deactivation of DMRS muting, and the value of bₘ may indicate the muting pattern. For example, a value of bₘ=0 may indicate a first muting pattern (for instance, that the last 2 DMRS resource elements in every physical resource block with the highest subcarrier indices are muted), and a value of bₘ=1 may indicate a second muting pattern (for instance, that the last 4 DMRS resource element in every physical resource block with the highest subcarrier indices are muted). If the field is absent, it may denote a deactivation of the DMRS muting.

In accordance with embodiments, UE 400 receives a scheduling of a PDxCH or PUxCH with repetition, and the UE may be configured via RRC or provided in the specifications with one or more muting patterns to be applied to a set of repetitions of the PDxCH or PUxCH. When such a list of patterns is configured or provided to the UE, the UE may receive one or more DCIs or MAC-CE messages that may indicate the muting pattern by providing the UE with an index that maps to a muting pattern in the provided list. In an example, the UE may be configured via RRC with muting patterns, e.g. in the format of a starting slot of the muting and the duration of the muting. When such a configuration is provided or enabled at the UE, the UE may one or more receive DCIs that may select or activate one or more muting patterns to be applied to one or more PxxCH transmissions.

In accordance with embodiments, UE 400 receives a scheduling of a PDxCH with repetition or a PUxCH with repetition, at least one of the PDxCH or PUxCH repetitions is performed with DMRS muting, and the indication of the muting of the DMRS for at least one repetition of the PDxCH or PUxCH is provided via the PHY layer. Here, the UE may be indicated with a muting pattern carried by a corresponding field dedicated to indicate one or more DMRS muting parameters in the DCI. For example, the DCI field may carry a bit string, and the size of the bit string specifies the number of the slots or transmission occasions for which the muting pattern applies. A value of bit “1” at a given position of the bit string specifies that the DMRS is deactivated for one or more PxxCHs in the corresponding slot or transmission occasion, and a value of “0” at a given position of the bit string specifies the slot for which DMRS is activated (or vice versa). If the field is absent, there may be no DMRS muting. The presence or absence of the field may be indicated via higher layer signaling, e.g., via a MAC-CE message or via a RRC configuration. The muting pattern provided in the bit string may be applied to slots or transmission occasions after the DCI. More specifically, it may be applied t′ milliseconds or slots or transmission occasions after the DCI, and the value of t′ may be provided by the network or may be preconfigured/fixed in the specifications.

It is to be noted that the term ‘after the DCI’ may mean ‘later than the first or last symbol associated with the reception of the DCI’.

In another example, the DCI field to indicate DMRS muting may carry a bit string that maps to an index or identification of a muting pattern configured via a higher layer or provided/preconfigured via the specifications.

In accordance with embodiments, UE 400 receives one or more PDxCHs or transmits one or more PUxCHs with DMRS muting, and the number of slots or transmission occasions for which the muting is performed is indicated by a network node via the PHY-layer or via a higher layer. For example, a field in a DCI may carry a bit string that indicates muting, and the size of the bit string determines the number of PDxCH or PUxCH occasions or slots for which DMRS muting is applicable. When the bit string size is equal to 1, the DMRS muting is activated or deactivated according to the value of the bit string for the scheduled PDxCH or PUxCH occasion only or to just one PDxCH or PUxCH occasion. When the bit string size is greater than 1, the DMRS muting may be applied for multiple PDxCH or PUxCH occasions after the DCI. This may include the PDxCH or PUxCH scheduled by the DCI, if the DCI is a PUxCH or PDxCH scheduling DCI. A value of bit “1” at a given position of the bit string specifies that the DMRS is deactivated for one or more PxxCHs in the corresponding slot or transmission occasion, and a value of “0” at a given position of the bit string specifies the slot for which DMRS is activated (or vice versa). If the field is absent, there may be no DMRS muting.

In accordance with embodiments, UE 400 receives one or more PDxCHs or transmits one or more PUxCHs with DMRS muting, and the frequency of the DMRS muting (how often DMRS muting occurs) for the one or more PDxCHs or PUxCHs are provided by the PHY-layer and/or a higher layer. For example, a DCI field or a MAC-CE message may carry the frequency of DMRS muting. For instance, a non-zero value of Y of a DMRS muting field in the DCI or a higher layer signaling may indicate that every Y-th PDxCH/PUxCH occasion or slot the DMRS is muted, while value Y=0, for example, may indicate that every PDxCH/PUxCH transmission is performed without muting DMRS (or vice versa).

### Partial Muting

In accordance with embodiments, muting of the DMRS, in general, for a DL or UL transmission may imply a full or complete muting of the DMRS, unless partial DMRS muting is specified explicitly. Partial muting may be realized in at least the following ways in time-domain and/or frequency-domain.

### Time-Domain: Reduction of the Number of Front-Loaded DMRS or the Number of Additional Positions

In accordance with embodiments, UE 400 receives a PDxCH or transmits a PUxCH, and the UE may be configured with a value A1 for additional number of DMRS positions in the associated DMRS configuration, and/or two front-load symbols may be indicated via the PHY-layer and/or via the higher layer for the associated DMRS of the PDxCH or PUxCH, and a partial muting of this DMRS configuration may be indicated by the network that involves the reception of the PDxCH or the transmission of the PUxCH whose DMRS is transmitted with at least one of the following settings:
a value A2 that is less than A1 for the additional number of DMRS positions,
a value of one for the number of front-load symbols.

The above is a quite generic approach and covers multiple modes of time-domain partial muting by reducing the number of additional symbols and the number of front-load symbols. In the following specific methods for controlling each of the two parameters are described in more detail. In accordance with embodiments, UE 400 receives a PDxCH or transmits a PUxCH, and the number of additional positions of the DMRS used for the PDxCH or PUxCH is set to a default value A, which may, for example, be 1 or 0, for one or more transmission occasions or slots, but a value different from A is configured or indicated for the number of additional positions in the associated DMRS configuration. The default value for the number of additional positions of the DMRS for the one or more transmission occasions or slots may be provided via a network, NW, node indication or configuration, e.g., a DCI indication, or may be preconfigured/fixed in the specifications. Optionally, this behavior of using a default value for the number of additional positions of the DMRS for a physical channel may be enabled by a configuration or indication from a NW node via the PHY-layer and/or a higher layer.

In accordance with embodiments, UE 400 receives a PDxCH or transmits a PUxCH, and the number of additional positions of the DMRS associated with the PDxCH or PUxCH is indicated via the PHY-layer or indicated via a combination of PHY- and higher layer. For example, a higher layer may indication a list of possible values or the maximum value for the number of additional DMRS positions and the DCI may choose one among the list or choose a value less than the configured maximum.

In accordance with embodiments, UE 400 receives a PDxCH or transmits or PUxCH, and a double symbol DMRS is scheduled for transmission and the UE assumes a single symbol DMRS to be associated with the transmission. The overriding of the double symbol DMRS transmission may be enabled via a NW node indication or configuration, or may be preconfigured/fixed in the specifications.

Frequency-Domain: Reduction of the Number of Resource Elements Associated with DMRS Configured Subcarrier Numbers

A frequency-domain-based muting may be typically partial. Similar to time-domain muting patterns and the application thereof described above, frequency domain muting methods are now described.

In accordance with embodiments, UE 400 receives a PDxCH (DL) or transmits a PUxCH (UL) that is associated with a DMRS configuration, and the UE applies a DMRS muting pattern in the frequency domain, i.e., applies a pattern of muting of DMRS resource elements across subcarriers in one or more symbols of the radio frame that comprises DMRS of the channel, a proper subset of resource elements associated with the DMRS configuration are muted, and the indication to apply the muting and/or the muting pattern for the subset of DMRS resource elements to mute is provided by the network via PHY-layer and/or a higher layer. Since the muting pattern is to be applied in the frequency domain, the pattern may be provided in terms of the subcarrier indices that are to be muted or left unmuted. For example, the UE may be configured, based on 5G NR specifications, with DMRS configuration Type 1 for a physical channel, wherein the DMRS occupies the subcarrier indices S_{DMRS}={0, 2, 4, 6, 8, 10} in each PRB and the UE may receive a DMRS muting indication via the PHY layer or via a higher layer that DMRS resource elements with subcarrier indices belonging to the subset S_{DMRS}^{Muted}⊂S_{DMRS} are to be muted in each PRB, e.g., S_{DMRS}^{Muted}={8,10}.

In another example, the UE may be configured, based on 5G NR specifications, with DMRS configuration Type 2, wherein the DMRS occupies the subcarrier indices S_{DMRS}={0, 1, 6, 7} in each PRB and the UE may receive a DMRS muting indication via the PHY layer or via a higher layer that DMRS resource elements with subcarrier indices belonging to the subset S_{DMRS}^{Muted}⊂S_{DMRS} are to be muted in each PRB, e.g., S_{DMRS}={6,7}.

In any of the embodiments, a partial muting configuration may be an application of partial muting in time-domain only, or in frequency-domain only, or a joint time-domain and frequency-domain partial muting.

### Physical Resource Mapping for Partial DMRS Muting

A partial DMRS muting may be enabled via the DMRS resource mapping method for a given channel.

In accordance with embodiments, the UE assumes a mapping (or maps) a DMRS sequence r(m) of a DMRS configuration of a physical channel to resource elements at symbol index l, subcarrier index k, port index p and waveform numerology u according to

$${s}_{k , l}^{( p , μ )} = {β}_{PDSCH}^{DMRS} {w}_{f} ( {k}^{′} ) {w}_{t} ( {l}^{′} ) r ( 2 n + {k}^{′} )$$

with
n a first index wherein n=0, 1, . . .
k′ a second index wherein k′={0,1}
l′ a third index wherein l′={0,1}
β_{PDSCH}^{DMRS} a real-valued, positive scalar
w_{f}(k′) a sequence of real or complex-valued entries specific for a port p, defined over k′
wₜ(l′) a sequence of real or complex-valued entries specific for a port p, defined over l′.
s_{k,l}^{(p,μ)} denotes the real-/complex-valued baseband amplitude that is mapped to the DMRS resource element associated with the parameters l, k, p and μ.

In the above method, the mapping assumption is made by the UE for a physical channel that the UE receives (say, from a network node). For a physical channel that is transmits (to a network node), the UE performs this mapping.

In accordance with embodiments, the subcarrier index k used in the DMRS mapping for a port p is expressed as.

$$k = 4 n + 2 {k}^{′} + Δ , or$$

$$k = 6 n + {k}^{′} + Δ ,$$

wherein Δ corresponds to a CDM group index assigned to a port p. The first expression provides an allocation similar to DMRS configuration type 1 and the second expression provides an allocation similar to DMRS configuration type 2.

In accordance with embodiments, the symbol index l used in the DMRS mapping for a port p is expressed as l=l̅+l′, wherein l̅ is a position of (additional) DMRS in the slot. The value of l̅ may be configured/indicated to the UE by a network node.

In accordance with embodiments, the sequence w_{f}(k′) corresponds to an orthogonal cover code (OCC) defined over k′. This sequence helps in applying the orthogonal cover code in the frequency domain.

In accordance with embodiments, the sequence wₜ(l′) corresponds to an orthogonal cover code defined over l′. This sequence helps in applying the orthogonal cover code in the frequency domain.

In accordance with embodiments, the value β_{PDSCH}^{DMRS} is used to scale the transmission power of the DMRS.

### Realizing Frequency Domain Muting

In accordance with embodiment, the UE may assume a DMRS mapping to physical resource elements as provided in the specifications (for e.g., 3GPP specifications), wherein the mapping of the muted resource element(s) may be realized by setting the corresponding RE(s) to zero power.

The muting of DMRS resource elements in the frequency domain may be realized by muting resource elements that are associated with a predetermined set of values of the indices used for the DMRS sequence.

In accordance with embodiments, the value of w_{f}(k′) may be set to zero for either k′=0 or k′=1.

In accordance with embodiments, the value of s_{k,l}^{(p,μ)} may be set to zero for a proper subset of the possible values of n.

In accordance with embodiments, the value of s_{k,l}^{(p,μ)} may be set to zero, for at least one of the following cases:
when k′=0 or when k′=1,
n takes odd values, i.e., n={1, 3, 5, . . . }, or n takes even values, i.e., n={0, 2, 4, . . . },
n takes every other third value, i.e., n={2, 6, 9, . . . }.

In accordance with embodiments, the muting of DMRS resource elements may be realized as follows: the value of s_{k,l}^{(p,μ)} is multiplied with a variable, denoted by b(n, k′), resulting in the DMRS resource element \tilde{s}_{k,l}^{(p,μ)}=s_{k,l}^{(p,μ)}·b(n, k′), wherein b(n, k′) is equal to zero for a proper subset of the possible values of n and/or a value of k′=0 or 1. Specifically, b(n, k′) is equal to zero in at least one of the following cases:
when k′=0 or when k′=1,
n takes odd values, i.e., n={1, 3, 5, . . . }, or n takes even values, i.e., n={0, 2, 4, . . . }, n takes every other third value, i.e., n={2, 6, 9, . . . }.

The value of b(n, k′) is equal to 1 otherwise.

Ports association of PDxCH/PUxSCH with DMRS

The acquisition of the CSI for the demodulation of a PDxCH or PUxCH with DMRS muting is now described, which, in accordance with embodiments, may be important for a PDxCH or PUxCH with full DMRS muting.

PxxCH transmissions with DMRS ports indicated in the DCI

In accordance with embodiments, UE 400 receives a PDxCH with DMRS muting or transmits a PUxCH with DMRS muting, and the PDxCH or PUxCH is associated with DMRS ports that are indicated in a downlink control information or a higher layer configuration that schedules the PDxCH or PUxCH. A lack of association with a DMRS means that the DMRS resource elements are muted while the port association based on DMRS is intact. In accordance with embodiments, the DMRS for a DL or UL transmission is muted while providing a direction to the UE on the number of layers of transmission performed for the channel via the indication or configuration of the DMRS ports for said transmission. Also mapping of the channel state information from a previous transmission of a physical channel with the ports of a transmission of said channel with DMRS muting may be performed for decoding of said transmission with DMRS muting.

In accordance with embodiments, UE 400 obtains the channel information for a PDxCH or the gNB 406 obtains/derives the channel information for a PUxCH, and the PDxCH and PUxCH transmissions are performed with full DMRS muting from a reference PDxCH and PUxCH transmission, respectively, that was performed before the PDxCH or PUxCH. The reference PDxCH or PUxCH transmission may be received at the UE and at the gNB, respectively, t′ milliseconds or symbols or slots or transmission occasions before the PDxCH or PUxCH transmission, and t′ is provided by a network node or is provided in the specifications. Here, the channel information obtained/derived may include at least one of the following: channel coefficients, Doppler spread, delay spread.

PxxCH Transmissions without DMRS Ports Indication in the DCI

In accordance with embodiments, the port associated from a previous scheduling of a PDxCH or PUxCH may be taken, while the DMRS port indication in the DCI or a higher layer configuration or grant that schedules the PDxCH or PUxCH may not indicate any DMRS ports. For example, when the DMRS port indication field in a DCI that schedules a PUxCH or a PDxCH is used for the indication of the DMRS muting, the DMRS port indication for said channel is taken from a previous DCI that scheduled another transmission associated with the same channel.

In accordance with embodiments, UE 400 receives a PDSCH or transmits a PUSCH with DMRS muting, and the PDSCH or PUSCH is associated with DMRS ports that are indicated in a DCI before the reception of the DCI scheduling the PDSCH or PUSCH. The DCI in which the DMRS port indication is contained may be one or more of the following:
For a PDSCH, the DCI comprising the DMRS port indication is the latest DCI that schedules or indicates at least one PDSCH transmission, and that is received before the reception of the PDSCH or the reception of the DCI scheduling the PDSCH.
For a PUSCH, the DCI comprising the DMRS port indication is the latest DCI that schedules or indicates at least one PUSCH transmission, and that is received before the transmission of the PUSCH or the reception of the DCI scheduling the PUSCH.
For a PDSCH, the DCI comprising the DMRS port indication is the latest DCI that schedules at least one PDSCH transmission in which there is no partial or full DMRS muting, and that is received before the reception of the PDSCH or the reception of the DCI scheduling the PDSCH.
For a PUSCH, the DCI comprising the DMRS port indication is the latest DCI that schedules at least one PUSCH transmission in which there is no partial or full DMRS muting, and that is received before the transmission of the PUSCH or the reception of the DCI scheduling the PUSCH.

The ordering and/or the port indices obtained for a PDSCH or PUSCH with DMRS muting as above supports determining the number of layers, the codeword-to-layer mapping for each layer and the mapping of layers to DMRS port indices.

In accordance with embodiments, for a PDSCH/PUSCH transmission wherein
DMRS muting is performed, and/or
DMRS port mapping is obtained from a DCI received earlier than the DCI scheduling the PDSCH/PUSCH or from a previous PDSCH/PUSCH transmission,
   a part or all channel-related information (or channel state information, in general) for the resources of a given layer or data stream in said transmission may be obtained from that of the resources corresponding to the same DMRS port in a previous PDSCH/PUSCH transmission.
   PxxCH Transmissions without DMRS Configuration

For full DMRS muting, when there is no DMRS configuration associated with a given channel, obtaining of the channel information may not be straightforward.

In accordance with embodiments, UE 400 is provided with a configuration of a PDxCH or PUxCH via a higher layer (e.g., RRC) that is not associated with a DMRS configuration. In such cases, the UE has to be provided with at least one additional PDxCH or PUxCH configuration that is associated with a DMRS configuration.

In accordance with an embodiment, when the UE is scheduled with a first PDxCH or a PUxCH that is associated with a first PDxCH or PUxCH configuration for which no DMRS configuration is provided via a higher layer, the information regarding at least one of the following is obtained from a second PDxCH or PUxCH transmission that is associated with a second PDxCH and a PUxCH configuration, that is provided with a DMRS configuration via a higher layer and that is received or transmitted before the first PDxCH or PUxCH:
The DMRS ports indication associated with the second PDxCH or PUxCH.
The channel information associated with the DMRS ports of the second PDxCH or PUxCH.

### Overriding or Ignoring DMRS Muting

In some scenarios in which, without the DMRS, a PDxCH or PUxCH allocation may not fit the frame allocation, or in which, due to channel variations, a muting indication has to be ignored or overridden, a specification restriction may be introduced.

In accordance with embodiments, UE 400 receives a PDxCH or transmits a PUxCH without DMRS muting even though the transmission may be indicated or configured to be received or transmitted with DMRS muting. This may happen in at least one of the following occasions:
When the number of resource elements for PDxCH or PUxCH without any associated DMRS is not an integer multiple of N_{sc}^{RB}·N_{RB}·Nₛ·Nₗ, wherein N_{sc}^{RB}, N_{RB}, Nₛ and Nₗ take any valid positive integer values and represent the number of subcarriers per resource block (NB), the number of resource blocks (N_{RB}), the number of symbols (Nₛ) and the number of layers/data streams (Nₗ). It is noted that the term valid values for the resource allocation variables may mean that the variables may take any value permitted by the frame specifications for resource allocation. The data allocation of the physical channel with DMRS muting may be shrunk to a suitable size (number of PRBs, number of symbols, number of layers) for the scheduling DCI or higher layer configuration/grant to indicate the size of the packet. So, if after the muting, the shrinking may not fit any set of integer allocation values, then the allocation may not happen.
When the indication for DMRS muting activation/deactivation for a certain PUxCH transmission or PDxCH reception is overridden by a signaling from a MAC-CE or from a PHY-layer, i.e., when the DMRS muting activation/deactivation for a certain slot or transmission occasion is determined by a RRC or MAC-CE signaling, another signaling via the MAC-CE or PHY-layer may be used to indicate that the DMRS muting activation/deactivation is not valid for a certain PUxCH or PDxCH transmission. This type of override may be performed to momentarily keep the DMRS, e.g., when the relative velocity between the UE and the gNB is momentarily higher or when the resource allocation doesn't fit.

For the application of the above behavior, some UE capability parameters may be introduced. In accordance with embodiments, the UE is configured to report to a network node at least one of the following parameters:
A capability to override a muting indication
A capability to override a muting indication during a PDxCH or PUxCH transmission occasion, in case the PDxCH or PUxCH transmission occasion, with the DMRS muting, does not fit in the radio frame with any valid frame allocation parameters.

### Time Domain Resource Allocation

In the time domain, in accordance with embodiments, the resource allocation may be performed for a PUxCH or PDxCH transmission occasion that is applied with or without muting. When a certain muting pattern is already set to be applied, if a PUxCH or PDxCH transmission is performed on various occasions or slots and when a mix of both DMRS activated and deactivated slots or occasions are present, the time domain resource allocation may have to be adjusted for every occasion or slot accordingly.

In accordance with embodiments, UE 400 receives a DCI that schedules a PDSCH or a PUSCH with repetition and at least one parameter of the time allocation that is indicated via the DCI—like a starting position of the PUSCH transmission and PDSCH reception or a length of the transmission or reception in terms of the number of symbols (or the start and length indication vector, SLIV)—is applicable only in a proper subset of the slots or transmission occasions in which the PDSCH or PUSCH is scheduled. This helps in transitions between transmissions with muted DMRS and unmuted DMRS. For example, the starting position of the transmission or reception may be the same across all repetitions, while the length of the allocation may be applicable only to the one or more DMRS deactivated slots or transmission occasions or to the one or more DMRS activated slots or transmission occasions depending on the slot or transmission occasion in which the scheduling began.

For example, if the scheduling of the PDSCH or PUSCH with repetition begins in a slot or a transmission occasion without DMRS muting, then the time-domain allocation parameters may apply fully only to the slots or transmission occasions where the transmission is performed without DMRS muting. If not, at least one of the time-domain allocation parameters may not apply. For instance, the starting symbol for a transmission may be the same for all repetitions while the length value/vector may be different.

In another example, the time-allocation parameters may apply fully only to the slots or transmission occasions, and the transmission is performed without DMRS muting. For the other slots or transmission occasions, the DMRS resource elements are occupied by the scheduled PUxCH or PDxCH and only a proper subset (for e.g., a starting position/symbol) or none of the time-domain allocation parameters indicated in the DCI may apply.

### Transport Block Size Determination

In accordance with embodiments, UE 400 receives a PDxCH with DMRS muting or transmits a PUxCH with DMRS muting, wherein the UE determines the total number of available resource elements per physical resource block for a physical channel as follows:

$${N}_{RE}^{′} = {N}_{sc}^{RB} \cdot {N}_{symb}^{sh} - {N}_{DMRS}^{PRB} - {N}_{oh}^{PRB}$$

with
N_{sc}^{RB} a number of subcarriers in a physical resource block,
N_{symb}^{sh} a number of symbols of the physical channel allocation within the slot,
N_{DMRS}^{PRB} a number of REs for DM-RS per PRB in the scheduled duration including the overhead of the DM-RS CDM groups without data, and
Nₒₕ^{PRB} an overhead configured by a higher layer parameter.

In the case of full DMRS muting, the value of N_{DMRS}^{PRB} is set to zero

In the case of partial DMRS muting, the value of N_{DMRS}^{PRB} is set to a value that is less than the number of DMRS resource elements allocated via at least one of the following:
a higher layer DMRS configuration,
a DCI/MAC-CE signaling regarding the number of front-load symbols, DMRS ports indication, a PTRS-DMRS ports association.

The DMRS overhead reduction results in an increased N′_{RE}, the total number of REs available for PDxCH/PUxCH within a PRB, which may go up to N′_{RE}=168 in PDSCH/PUSCH occupying the whole slot and without any overheads.

The total number of REs in the slot is computed as N_{RE}=min (156, N′_{RE})·n_{PRB} with n_{PRB} being the total number of allocated PRBs for UE 400. Thus, using N_{RE}≤156 with DMRS muting, a larger transport block size than the one in the slots without DMRS muting is obtained. However, when N′_{RE}>156 with DMRS muting, the transport block size is limited through the minimum operator in N_{RE}=min (156, N_{RE})·n_{PRB}, which forces a minimum overhead assumption of 12 REs per PRB-just like how the transport block size does not change with different DMRS configurations (type 1 or type 2) involving not more than one DMRS symbol in the slot. This is because a value of N′_{RE} that is greater than 156 is not utilized to transmit a larger transport block and the overhead reduction advantage manifests through more encoded redundancy bits output by the rate matchers, in turn obtaining a slightly lower code rate that may offer an improved reliability.

In accordance with embodiments, the total number of REs allocated for PDxCH/PUxCH is computed in one of the following ways:
N_{RE}=min (Z, N′_{RE})·n_{PRB} where Z takes one of the following values: 162, 164, 168.
N_{RE}=N′_{RE}·n_{PRB}

This allows higher transport block sizes (while maintaining the target code rate) with DMRS muting as well as with different DMRS configurations (type 1 or type 2) involving only one DMRS symbol in the slot.

In the case of DMRS muting while repeating a transmission PxSCH transmission, the transport block size and the code block size do not change and the muted REs may either be unoccupied (zero power) or used for other transmissions.

### Consistent Parameters

In accordance with embodiments, UE 400 or a network node receives
a first transmission occasion of a PxxCH (or a scheduling of the same) with full or partial DMRS muting, and
a second transmission occasion of the same channel before the reception of said first transmission occasion, and
using the channel state information or channel information from the second transmission occasion for the first transmission occasion.

The channel information/channel state information (CSI) borrowed from the second transmission occasion may be used for the decoding of the first transmission occasion as DMRS is muted in it and only partial or no channel information is available from its DMRS.

In accordance with embodiments, UE 400 obtains, for a first transmission occasion of a physical channel with fully or partially muted DMRS, channel information from a second transmission occasion of a physical channel previous to the first one, wherein the first transmission occasion is a current physical channel transmission, and the second transmission occasion is a reference physical channel transmission, the current and reference physical channel comprising a PDCCH or a PDSCH, and wherein the UE uses the channel information from the reference physical channel transmission for the current physical channel transmission. The current and physical channel transmissions, in this case, may be transmitted by a network node.

In accordance with embodiments, a network node obtains, for a first transmission occasion of a physical channel with fully or partially muted DMRS, channel information from a second transmission occasion of a physical channel previous to the first one, wherein the first transmission occasion is a current physical channel transmission, and the second transmission occasion is a reference physical channel transmission, the current and reference physical channel comprising a PUCCH or a PUSCH, and wherein the network node uses the channel information from the reference physical channel reception for the current physical channel transmission. The current and physical channel transmissions, in this case, may be transmitted by a user equipment.

It may be necessary for certain parameters to be identical or similar across the PxxCH occasions with and without DMRS muting to allow borrowing the channel information.

In accordance with embodiments, UE 400 receives a first PDSCH transmission occasion or a scheduling of the same with DMRS muting from a network node, wherein one or more of the following parameters associated with the first PDSCH are identical to or obtained/derived from a second PDSCH transmission received from a network node before said first PDSCH: the one or more TCI-states, the one or more physical resource block bundling parameters, the modulation and coding scheme, MCS, the DMRS ports, the precoding. Parameters that are to be derived/obtained or are identical with the second PDSCH may not be indicated in the scheduling information for the first PDSCH. Here, the first and second PDSCHs are the current and reference PDSCH transmissions, respectively.
The second PDSCH with which said first PDSCH's parameters are to be identical may be referred to as reference PDSCH transmission and the first PDSCH may be referred to as the current PDSCH transmission. The reference PDSCH transmission may be one of the following: the latest PDSCH transmission received by the UE before the current PDSCH transmission.
The latest PDSCH transmission received by the UE before the current PDSCH transmission with the same HARQ process or transport block ID, the PDSCH transmission scheduled by a DCI associated with the same CORESET pool index as the DCI scheduling the current PDSCH.

In accordance with embodiments, UE 400 receives a first PDCCH on a CORESET with DMRS muting from a network node, wherein one or more of the following parameters associated with the first PDCCH are identical to a second PDCCH transmission received from a network node before said first PDCCH: the one or more TCI-states, the associated CORESET, the precoding granularity (like REG bundle level, wideband, subband, etc.), the aggregation level, the associated search space set.

The second PDCCH with which the parameters of the first PDCCH are to be identical may be referred to as reference PDCCH transmission and the first PDCCH may be referred to as the current PDCCH transmission. The reference PDCCH transmission may be one of the following:
the PDCCH candidate with the same index as the current PDCCH received by the UE in the latest occasion of the identical search space set, or
the PDCCH candidate with the same index as the current PDCCH received by the UE in an occasion of the identical search space set t′ symbols or slots or milliseconds before the current PDCCH.

Similarly, such restrictions may also be included for PUSCH and PUCCH.

In accordance with embodiments, UE 400 transmits a first PUSCH transmission occasion with DMRS muting, wherein at least one of the following parameters are identical to or obtained/derived from a second PUSCH transmission performed before said first PUSCH: the spatial relation information or the one or more TCI states, the precoding and/or physical resource block bundling parameters, the MCS, the DMRS ports, the power control parameters, like p0, closed loop index, alpha, etc., the pathloss reference RS, the SRS resource indicator. The UE may perform the transmission of said first PUSCH to a network node by utilizing said one or more parameters of the second PUSCH transmitted before the first one. Parameters that are to be derived/obtained or are identical with the second PUSCH may not be indicated in the scheduling information for the first PUSCH. A network node may receive said first and second PUSCH transmissions.

The second PUSCH with which the first PUSCH's parameters are to be identical may be referred to as reference PUSCH transmission and the first PUSCH may be referred to as the current PUSCH transmission. The reference PUSCH transmission may be one of the following:
the latest PUSCH transmission performed by the UE before the current PUSCH transmission,
the latest PUSCH transmission performed by the UE before the current PUSCH transmission with the same HARQ process or transport block ID, or
the PUSCH transmission scheduled by a DCI associated with the same CORESET pool index as the DCI scheduling the current PUSCH.

In accordance with embodiments, UE 400 transmits a first PUCCH transmission occasion with DMRS muting, wherein at least one of the following parameters are identical to or obtained/derived from a second PUCCH transmission performed before the first PUCCH: the spatial relation information or the one or more TCI states, the precoding and/or the one or more physical resource block bundling parameters, the power control parameters, like p0, closed loop index, alpha, etc., the pathloss reference RS, the PUCCH resource group, the PUCCH resource set. The UE may perform the transmission of said first PUCCH to a network node by utilizing said one or more parameters of the second PUCCH transmitted before the first one. A network node may receive said first and second PUCCH transmissions.

The second PUCCH with which the first PUCCH's parameters are to be identical may be referred to as reference PUCCH transmission and the first PUCCH may be referred to as the current PUCCH transmission. The reference PUCCH transmission may be one of the following:
the latest PUCCH transmission performed by the UE associated with the same PUCCH resource as the current PUCCH transmission,
the latest PUCCH transmission performed by the UE before the current PUCCH transmission.
the PUCCH transmission scheduled by a DCI associated with the same CORESET pool index as the DCI scheduling the current PUCCH,
the PUCCH transmission performed by the UE associated with the same PUCCH resource group, PUCCH resource set or CORESET pool index as the current PUCCH.

In accordance with embodiments, a reference PDSCH/PUSCH/PDCCH/PUCCH transmission may be performed with partial or no DMRS muting.

In the above embodiments, the reference channel may be obtained up to t′ symbols or slots or milliseconds before the transmission. The value of t′ may be preconfigured/predetermined by the specifications or indicated via a network node to the UE via the PHY-layer and/or a higher layer. This ensures that the information borrowed is up to date.

In accordance with further embodiments, in addition to the above parameters, the resource allocation parameters may also be similar between the source channel transmission and the reference channel. In accordance with embodiments, UE 400 receives a PDxCH or transmits a PUxCH, and the set of physical resource blocks allocated for the PDxCH or PUxCH is a subset of or identical to the set of physical resource blocks allocated for a reference PDxCH or for a reference PUxCH received before the PDxCH or transmitted before the PUxCH, respectively.

In accordance with embodiments, UE 400 receives a PDxCH or transmits a PUxCH, and the number of symbols allocated for the PDxCH or PUxCH is less than or equal to the number of symbols allocated for a reference PDxCH or a reference PUxCH received before the PDxCH or transmitted before the PUxCH, respectively.

In accordance with embodiments, UE 400 receives a PDxCH or transmits a PUxCH, and the set of symbols allocated for the PDxCH or PUxCH within a slot is a subset of or identical to the set of symbols allocated for a reference PDxCH or a reference PUxCH within its slot and is received before the PDxCH or transmitted before the PUxCH, respectively.

### PTRS Association and Allocation

The DMRS muting may be extended for PTRS at the UE. In accordance with embodiments, UE 400 receives a PDxCH or PUxCH scheduling, and the PTRS is muted/deactivated when the DMRS is muted/deactivated due to the application or activation of a DMRS muting. The overriding of the DMRS muting indication that may be used in certain cases as described may also apply jointly for DMRS and PTRS.

A decoupling the PTRS and DMRS muting may enable separate control of the two different reference signals. In accordance with embodiments, UE 400 receives a signaling via the PHY-layer and/or via one or more higher layers regarding the muting of PTRS for one or more PxxCH transmission occasions or slots that is separate from the corresponding signaling regarding the muting of DMRS. The signaling may perform at least one of the following tasks:
Indicate an activation of a PTRS muting.
Indicate a pattern of muting for PTRS
Indicate a frequency of muting for PTRS

A partial or full muting of the PTRS may be performed similar to DMRS. For partial muting, a proper subset of the symbols for which the PTRS is transmitted may be muted. In another embodiment, a parameter regarding time domain PTRS density may be reset.

In accordance with embodiments, UE 400 receives a PDxCH or transmits a PUxCH, and a time density of the PTRS used for the PDxCH or PUxCH is set to a default value B for one or more transmission occasions or slots, but a value different from B is configured or indicated in the associated PTRS configuration. The assumption of the default value for the time density of the PTRS for the one or more transmission occasions or slots may be enabled via a NW node indication or configuration, or may be preconfigured/fixed in the specifications.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and entailing input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

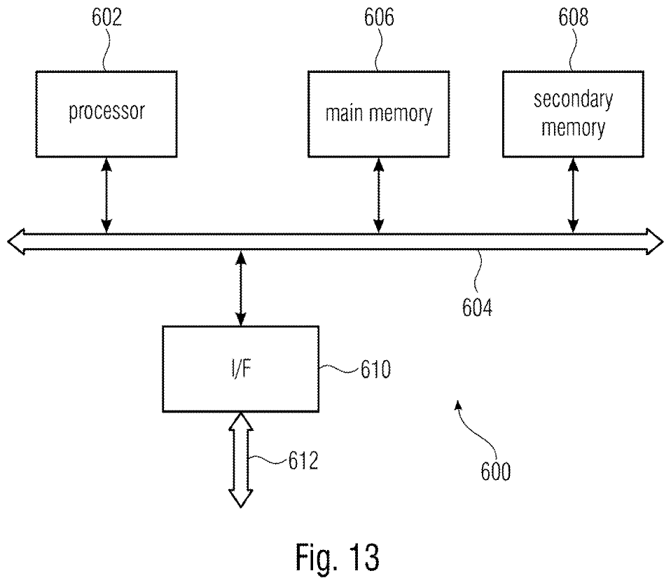

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 13 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] 3GPP TS 38.211 V16.7.0: “3GPP; TSG RAN; NR; Physical channels and modulation (Rel. 16),” September 2021.
[2] 3GPP TS 38.212 V16.7.0: “3GPP; TSG RAN; NR; Multiplexing and channel coding (Rel. 16),” September 2021.
[3] 3GPP TS 38.213 V16.7.0: “3GPP; TSG RAN; NR; Physical layer procedures for control (Rel. 16),” September 2021.
[4] 3GPP TS 38.214 V16.7.0: “3GPP; TSG RAN; NR; Physical layer procedures for data (Rel. 16),” September 2021.
[5] 3GPP TS 38.321 V16.6.0: “3GPP; TSG RAN; NR; Medium Access Control (MAC) protocol specification (Rel. 16),” September 2021.
[6] 3GPP TS 38.331 V16.6.0: “3GPP; TSG RAN; NR; Radio Resource Control (RRC); Protocol specification (Rel. 16),” September 2021.
[7] 3GPP TS 38.101-1 V 17.3.0: “3GPP; TSG RAN; User Equipment (UE) radio transmission and reception; Part 1: Range 1 Standalone,” October 2021.

1. A user device, UE, for a wireless communication system,
wherein the UE is configured to receive and/or transmit one or more physical channel transmissions, and
wherein at least one of the physical channel transmissions is received or transmitted with a partial or full DeModulation Reference Signal, DMRS, muting,
wherein
the partially muted DMRS transmission is associated with a DMRS configuration for the physical channel, and wherein a proper subset of the resources that are associated with the DMRS are muted, and
the fully muted DMRS transmission is associated with a DMRS configuration for the physical channel, and wherein all of the resources that are associated with the DMRS are muted,
wherein a muted resource is occupied by information other than the DMRS, and
wherein the said information other than the DMRS occupying a muted resource comprises one or more of the following:
a part of a payload of the associated physical channel transmission,
a part of a payload of a different physical channel transmission,
any physical signal other than the DMRS,
wherein the UE is configured to receive for at least one transmission occasion of the physical channel transmission an indication activating DMRS muting at a certain time instant for a certain duration.

2. (canceled)

3. The user device, UE, of claim 1, wherein the UE is
configured or preconfigured with an absence of associated DMRS or a presence of partial or full DMRS muting during a certain physical channel transmission occasion, and/or
to receive an indication of an absence of associated DMRS or a presence of partial or full DMRS muting during a certain physical channel transmission occasion from a network node of the wireless communication system via a physical, PHY, layer or via a media access control, MAC, layer, or via a higher layer, like an indication in a radio resource control, RRC, layer.

4. (canceled)

5. The user device, UE, of claim 1, wherein the UE is configured to receive a downlink control information, DCI, that indicates an activation or a deactivation of DMRS muting for at least one physical channel at at least one physical channel transmission occasion.

6. The user device, UE, of claim 5, wherein the activation or deactivation of DMRS muting for a physical channel transmission is indicated in a DCI used for scheduling said physical channel transmission.

7-8. (canceled)

9. The user device, UE, of claim 1, wherein the UE is configured to receive a signaling that indicates an activation of DMRS muting for at least one repetition of a physical channel associated with the same transport block.

10-11. (canceled)

12. The user device, UE, of claim 1, wherein the UE is configured to receive a signaling that indicates an activation or a deactivation of DMRS muting for at least one physical channel at at least one physical channel transmission occasion, wherein the signaling is associated with a DMRS muting pattern, the DMRS muting pattern indicating DMRS muting in the time-domain for at least one physical channel transmission occasion or DMRS muting in the frequency-domain for a set of subcarriers associated with resource elements configured for a DMRS transmission.

13-18. (canceled)

19. The user device, UE, of claim 1, wherein
the UE is configured to receive or transmit a physical channel that is associated with a DMRS configuration, and
in case of partial DMRS muting, for realizing the partial DMRS muting in the frequency-domain, the UE is configured to receive, from a network entity of the wireless communication system, an indication of a proper subset of resource elements associated with the DMRS configuration that are to be muted.

20. The user device, UE, of claim 1, wherein the UE is configured to
receive or transmit a physical channel with an absence of associated DMRS or a presence of partial or full DMRS muting, and
receive a scheduling of the physical channel that indicates the DMRS ports that are associated with the physical channel.

21. The user device, UE, of claim 20, wherein, for receiving the physical channel, the UE is configured to obtain a channel information from an earlier physical channel transmission performed without DMRS muting.

22-26. (canceled)

27. The user device, UE, of claim 1, wherein, when the UE is indicated by a network node to receive or transmit a physical channel in at least one transmission occasion with an absence of associated DMRS or a presence of partial or full DMRS muting, the UE is configured to receive or transmit said at least one transmission occasion of said physical channel without DMRS muting in a specific occasion.

28-30. (canceled)

31. The user device, UE, of claim 1, wherein
if the scheduling of the physical channel with repetition begins in a transmission occasion without DMRS muting, the one or more time allocation parameters apply fully only to the transmission occasions wherein the transmission is performed without DMRS muting, or
if the scheduling of the physical channel with repetition does not begin in a transmission occasion without DMRS muting, at least one of the time-domain allocation parameters does not apply, e.g., a starting symbol for a transmission may be the same for all repetitions while a length value/vector may be different, or
the one or more time allocation parameters apply fully only to the transmission occasions where the transmission is performed without DMRS muting, and wherein only a proper subset or none of the one or more time-domain allocation parameters apply to the transmission occasions where the transmission is performed with an absence of associated DMRS or a presence of partial or full DMRS muting.

32. The user device, UE, of claim 1, wherein, when the UE is to receive or transmit a physical channel with full DMRS muting, the UE is configured to determine the total number of available resource elements per physical resource block for a physical channel as follows:
$${N}_{RE}^{′} = {N}_{sc}^{RB} \cdot {N}_{symb}^{sh} - {N}_{DMRS}^{PRB} - {N}_{oh}^{PRB}$$
with
N_{sc}^{RB} a number of subcarriers in a physical resource block,
N_{symb}^{sh} a number of symbols of the physical channel allocation within the slot,
N_{DMRS}^{PRB} a number of REs for DM-RS per PRB in the scheduled duration including the overhead of the DM-RS CDM groups without data, and
Nₒₕ^{PRB} an overhead configured by a higher layer parameter, and
wherein the UE is configured to set N_{DMRS}^{PRB} to zero.

33. The user device, UE, of claim 1, wherein, when the UE is to receive or transmit a physical channel with partial DMRS muting, the UE is configured to determine the total number of available resource elements per physical resource block for a physical channel as follows:
$${N}_{RE}^{′} = {N}_{sc}^{RB} \cdot {N}_{symb}^{sh} - {N}_{DMRS}^{PRB} - {N}_{oh}^{PRB}$$
with
N_{sc}^{RB} a number of subcarriers in a physical resource block,
N_{symb}^{sh} a number of symbols of the physical channel allocation within the slot,
n_{DMRS}^{PRB} a number of REs for DM-RS per PRB in the scheduled duration including the overhead of the DM-RS CDM groups without data, and
Nₒₕ^{PRB} an overhead configured by a higher layer parameter, and
wherein the UE is configured to set N_{DMRS}^{PRB} to a value that is less than the number of DMRS resource elements allocated via at least one of the following:
a higher layer DMRS configuration,
a DCI/MAC-CE signaling regarding the number of front-load symbols, DMRS ports indication, a PTRS-DMRS ports association.

34. (canceled)

35. The user device, UE, of claim 1, wherein the UE is configured to obtain, for a first transmission occasion of a physical channel with an absence of associated DMRS or a presence of partial or full DMRS muting, channel information from a second transmission occasion of a physical channel previous to the first one,
wherein the first transmission occasion is a current physical channel transmission, and the second transmission occasion is a reference physical channel transmission, the current and reference physical channel comprising one of a PDCCH, a PDSCH, a PUCCH or a PUSCH, and
wherein the UE uses the channel information from the reference physical channel transmission for the current physical channel transmission.

36-41. (canceled)

42. A network entity for a wireless communication system, the wireless communication system comprising one or more user devices, UEs,
wherein the network entity is configured to receive and/or transmit one or more physical channel transmissions from and/or to a UE, and
wherein one or more of the physical channel transmissions are received or transmitted with a partial or full DeModulation Reference Signal, DMRS, muting,
wherein
the partially muted DMRS transmission is associated with a DMRS configuration for the physical channel, and wherein a proper subset of the resources that are associated with the DMRS are muted, and
the fully muted DMRS transmission is associated with a DMRS configuration for the physical channel, and wherein all of the resources that are associated with the DMRS are muted,
wherein a muted resource is occupied by information other than the DMRS, and
wherein the said information other than the DMRS occupying a muted resource comprises one or more of the following:
a part of a payload of the associated physical channel transmission,
a part of a payload of a different physical channel transmission,
any physical signal other than the DMRS,
wherein the UE is configured to receive for at least one transmission occasion of the physical channel transmission an indication activating DMRS muting at a certain time instant for a certain duration.

43-44. (canceled)

45. A method for operating a user device, UE, for a wireless communication system, the method comprising:
receiving and/or transmitting, by the UE, one or more physical channel transmissions,
wherein at least one of the physical channel transmissions are received or transmitted with a partial or full DeModulation Reference Signal, DMRS, muting
wherein
the partially muted DMRS transmission is associated with a DMRS configuration for the physical channel, and wherein a proper subset of the resources that are associated with the DMRS are muted, and
the fully muted DMRS transmission is associated with a DMRS configuration for the physical channel, and wherein all of the resources that are associated with the DMRS are muted,
wherein a muted resource is occupied by information other than the DMRS, and
wherein the said information other than the DMRS occupying a muted resource comprises one or more of the following:
a part of a payload of the associated physical channel transmission,
a part of a payload of a different physical channel transmission,
any physical signal other than the DMRS,
wherein the UE receives for at least one transmission occasion of the physical channel transmission an indication activating DMRS muting at a certain time instant for a certain duration.

46. (canceled)

47. A method for operating a network entity for a wireless communication system, the wireless communication system comprising one or more user devices, UEs, the method comprising:
receiving and/or transmitting, by the network entity, one or more physical channel transmissions from and/or to a UE,
wherein one or more of the physical channel transmissions are received or transmitted with a partial or full DeModulation Reference Signal, DMRS, muting,
wherein
the partially muted DMRS transmission is associated with a DMRS configuration for the physical channel, and wherein a proper subset of the resources that are associated with the DMRS are muted, and
the fully muted DMRS transmission is associated with a DMRS configuration for the physical channel, and wherein all of the resources that are associated with the DMRS are muted,
wherein a muted resource is occupied by information other than the DMRS, and
wherein the said information other than the DMRS occupying a muted resource comprises one or more of the following:
a part of a payload of the associated physical channel transmission,
a part of a payload of a different physical channel transmission,
any physical signal other than the DMRS,
wherein the UE receives for at least one transmission occasion of the physical channel transmission an indication activating DMRS muting at a certain time instant for a certain duration.

48. (canceled)

49. A non-transitory computer program product comprising a computer readable medium storing instructions which, when executed on a computer, perform the method of claim 45 or 47.
